(19) United States
(12) Patent Application Publication
(10) Pub. No.: US 2026/0300120 A1
(43) Pub. Date: Oct. 1, 2026

(54) Optimization of Granularity of Data Placed Across Memory Regions of Difference Characteristics

(71) Applicant: Micron Technology, Inc., Boise, ID (US)

(72) Inventors: Kamil Khan, Folsom, CA (US); Poorna Kale, Folsom, CA (US)

(21) Appl. No.: 19/092,817

(22) Filed: Mar. 27, 2025

(51) Int. Cl. G06F 11/34

(52) U.S. Cl. CPC G06F 11/3428; G06F 11/3423; G06F 11/349

(57) ABSTRACT

A system including: a processing device; a main memory; a memory bus coupled between the processing device and the main memory; a secondary random access memory; and a compute express link fabric separated from the memory bus and coupled between the processing device and the secondary random access memory. The system is configured to manage, using a reinforcement learning technique with rewards configured based at least in part on a ratio of parallel accessing to the main memory and the random access memory, a granularity of mapping logical memory blocks to physical memory blocks in the main memory and in the secondary the random access memory.

### TECHNICAL FIELD

At least some embodiments disclosed herein relate to memory systems in general and, more particularly but not limited to, memory accessed via compute express link connections.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The embodiments are illustrated by way of example and not limitation in the figures of the accompanying drawings in which like references indicate similar elements.

FIG. 1 illustrates an example computing system having a host system and a memory sub-system configured in accordance with some embodiments of the present disclosure.

FIG. 2 to FIG. 4 show techniques to provide a secondary tier memory according to some embodiments.

FIG. 5 shows a compute express link fabric configured to provide a secondary tier memory according to one embodiment.

FIG. 6 shows the attaching of dynamic capacity devices over a compute express link fabric to provide a random access memory according to one embodiment.

FIG. 7 shows a mapped memory space implemented via a compute express link fabric to provide a dynamically adjustable random access memory according to one embodiment.

FIG. 8 illustrates a controller of a compute express link (CXL) fabric caching portions of memory sub-systems in the memory space provided by memory devices connected to the fabric according to one embodiment.

FIG. 9 shows a compute express link switch configured to implement a dynamically adjustable random access memory according to one embodiment.

FIG. 10 shows a technique to implement requested memory using memory regions of different characteristics according to one embodiment.

FIG. 11 shows an access ratio to be optimized using a reinforcement learning agent according to one embodiment.

FIG. 12 shows an example of state parameters for a reinforcement learning agent to select parameters used in implementing requested memory according to one embodiment.

FIG. 13 shows an example of performance metrics for the determination of a reward for a reinforcement learning agent to select parameters used to implement requested memory according to one embodiment.

FIG. 14 shows an example of memory usage statistics that can be used as part of state parameters for implementation of requested memory according to one embodiment.

FIG. 15 shows a technique to construct a reward for a reinforcement learning agent to identify parameters to implement memory according to one embodiment.

FIG. 16 shows a method to implement memory according to one embodiment.

FIG. 17 is a block diagram of an example computer system in which embodiments of the present disclosure can operate.

### DETAILED DESCRIPTION

Different workloads can have different demands on memory resources. Without explicit information about workloads, memory resources in a computing system can be inadequately configured, causing over-provisioning in some aspects and/or under-provisioning in other aspects.

At least some aspects of the present disclosure address the above and other deficiencies and challenges by implementing a random access memory via a compute express link (CXL) fabric to a host processor, where at least some aspects (e.g., capacity, bandwidth, latency, power consumption level) of the random access memory can be defined and/or adjusted via software running in the host processor.

Dynamic capacity devices (DCDs) are logical memory devices supported by a standard of compute express link (CXL), where the capacity of a dynamic capacity device attached via compute express link (CXL) to a host system can be adjusted or changed without restarting the host system and/or without restarting the computing system containing the host system and the memory device.

In at least some embodiments disclosed herein, a host system can dynamically request changes in characteristics/attributes of the random access memory attached to the host system via CXL connections without restarting. Such characteristics/attributes can include capacity, bandwidth, latency, or power consumption level, or any combination thereof.

For example, the random access memory of a host processor can be implemented via a set of dynamic capacity devices offered by a plurality of memory devices of different characteristics, such as bandwidth, latency, power consumption level, etc. The dynamic capacity devices are attached to the host processor at the time of booting up the computing system containing the host processor and the memory devices. The capacity sizes of the dynamic capacity devices can be adjusted at the run time of the host processor without restarting.

By requesting the memory devices to change the capacity sizes of the dynamic capacity devices, the host processor can dynamically change the ratio of memory resources allocated from the memory devices of different characteristics to implement the random access memory of the host processor. Changing the memory resource allocation ratio can change the characteristics/attributes of the random access memory attached to the host processor.

For example, the host processor can determine the desirable characteristics/attributes of the random access memory based on the requirements or demands of the applications running in the host processor. The host processor can request changes in the capacity sizes of the dynamic capacity devices in a way such that the random access memory has characteristics/attributes that meet the requirements or demands of the applications.

Dynamic capacity devices offered by memory devices connected to a CXL fabric have performance levels of the respective memory devices in servicing a host processor over the fabric. For example, due to the connection topology and/or the differences in the memory devices as manufactured, the memory devices can have different performance levels in bandwidth, latency, and/or power consumption in servicing the host processor over the CXL fabric. Changing the distribution of capacity sizes across the dynamic capacity devices attached to the host processor can change various aspects (e.g., capacity, bandwidth, latency, power consumption level) of the random access memory implemented using the dynamic capacity devices.

In some implementations, the CXL fabric is configured to allocate memory resources from memory devices connected to the CXL fabric to implement logical memory devices attached to host processors. For example, the logical memory devices can be offered by the CXL fabric in a form of dynamic capacity devices that are attached to the host processors during the boot up time. The CXL fabric can dynamically change the mapping of memory addresses in the logical memory devices to the memory resources allocated from the memory devices to change the aspects (e.g., capacity, bandwidth, latency, power consumption level) of the local memory devices offered by the CXL fabric to the host processors.

In general, a set of compute express link (CXL) connections, a CXL switch, and/or a CXL fabric containing one or more CXL switches interconnected by CXL connections can be used to connect a plurality of memory devices to one or more host processors, such as a central processing unit (CPU), a graphical processing unit (GPU), a system on a chip (SoC), an artificial intelligence (AI) accelerator, etc. Each of the memory devices and/or a controller of the CXL fabric can offer a plurality of dynamic capacity devices. Each of the dynamic capacity devices can be attached to a host processor such that the host processor has a secondary tier of memory that is dynamically adjustable in various aspects, such as capacity, bandwidth, latency, power efficiency, etc.

A plurality of dynamic capacity devices can be attached to a host processor during the boot time of the computing system. The dynamic capacity devices provide a secondary tier memory for the host processor. The host processor can adjust the nominal performance levels of the secondary tier memory in capacity, bandwidth, latency, power efficiency, etc. by requesting changes in the capacity sizes of the dynamic capacity devices. When a dynamic capacity device is offered by the controller of the CXL fabric, the host processor can request the controller to implement the dynamic capacity device according to a performance level specified by the host processor. The plurality of dynamic capacity devices as a whole can provide the secondary tier memory to supplement the primary tier memory of the host processor (e.g., the main memory connected to the host processor via a memory bus, such as a double data rate bus).

Due to the differences in the memory devices and/or their locations in the network of CXL connections from the memory devices to the host processor, the plurality of dynamic capacity devices offered by the memory devices can have different performance levels in bandwidth, latency, and/or power consumption. The host processor can determine a combination of capacity sizes of the dynamic capacity devices such that the secondary tier memory has performance levels in capacity, bandwidth, latency, and/or power consumption that meet, or approximately match with (e.g., in average over time), a memory configuration requirement identified by the host processor for the applications running in the host processor.

Other dynamic capacity devices can be attached over the CXL connections, switch and/or fabric to one or more other host processors to service their applications.

Since the capacity of each dynamic capacity device attached to a host processor can be changed dynamically without restarting, and the characteristics of logical memory devices implemented by the controller of the CXL fabric can change without restarting, a software component running in the host processor can determine and adjust the ratio of capacity distribution across the dynamic capacity devices that are attached to the host processor, such that the average performance level of the random access memory, implemented as the secondary tier memory using the dynamic capacity devices, matches with or satisfies a memory performance target of one or more applications currently running in the host processor.

By tweaking the distribution of capacity sizes across the dynamic capacity devices attached to a host processor, the host processor can effectively allocate, over a CXL switch or fabric, a random access memory having a target performance level needed for the applications currently running in the host processor. The random access memory can have a capacity, bandwidth, latency, and/or power consumption level defined or requested by a software component (e.g., an operating system or a hypervisor) running in the host processor. Customization of characteristics of the random access memory used by the host processor over the CXL switch or fabric as a secondary tier memory can be performed on-demand and at a runtime of applications without hardware changes.

The memory resources connected to the CXL switch or fabric but not used by the host processor can be allocated and used by one or more other host processors connected to the CXL switch or fabric. Different host processors can have their respective secondary tier memory of different characteristics (e.g., capacity, bandwidth, latency, and/or power consumption), implemented using different portions of the same set of physical memory devices connected to the CXL switch or fabric.

For example, a software component (e.g., an operating system or a hypervisor) running in the host processor can define the capacity of the secondary tier memory (e.g., the total amount of data that can be stored in the secondary tier memory). When the applications running in the host processor needs more memory, the software component can request one or more of the dynamic capacity devices attached to the host processor to increase capacity; and when the applications running in the host processor finishes using the memory, the software component can return the excessive memory by requesting the one or more dynamic capacity devices to decrease capacity.

For example, a software component (e.g., an operating system or a hypervisor) running in the host processor can identify the bandwidth of the secondary tier memory (e.g., the rate at which the secondary tier memory can read or write data) to support the applications running in the host processor. Depending on the topology of the CXL network and the location of the dynamic capacity devices, different memory regions on the CXL network can be accessed by the host processor with different memory bandwidth levels, even when each memory device has a same memory bandwidth when the memory device is used in a direct connection. The availability of communication bandwidths in the CXL network and/or real time communication traffic pattern in the CXL network can limit the memory bandwidth of a memory device in serving the host processor. For example, a dynamic capacity device can be attached directly to a host through one or more CXL/PCI lanes for an increased bandwidth, or through one or more CXL switches over a network of CXL connections shared by different host processors and/or memory devices for a reduced bandwidth. Depending on application requirements, the software component running in the host processor can decide how to make capacity adjustments to the dynamic capacity devices to meet a memory bandwidth requirement (or an average memory bandwidth target).

For example, a component running in the host processor can identify the latency of the secondary tier memory (e.g., the delay between a memory request sent from a processor and a response received in the processor in response to the request) to support the applications running in the host processor. The latency of a dynamic capacity device connected via one or more compute express link (CXL) connections (e.g., connected directly or through one or more CXL switches) can be dependent on the overhead in communications over the CXL connections, runtime sharing of CXL connections, communications traffic conditions, and the latency of the memory device responding to a request. The software component running in the host processor can select capacity adjustment requests for the dynamic capacity devices attached to the host processor such that the secondary tier memory meets a latency requirement (or an average memory latency), in view of the various factors that can impact the latency of the secondary tier memory.

For example, a software component running in the host processor can identify a desirable power consumption level of the secondary tier memory for the secondary tier memory. Different dynamic capacity devices can have different power profiles. Depending on the cost goals of a computing system and/or applications, the software can power-down power-hungry memory devices connected to the CXL fabric to reduce memory power consumption, and utilize power-efficient memory devices at an acceptable level of performance degradation.

A software layer can be configured to implement tiering management across kernel-space and/or user-space. The software layer can manage (e.g., based on memory access patterns) the placement and movement of memory pages in and among the primary tier memory (e.g., the main memory provided over a memory bus, such as a double data rate (DDR) memory bus) and the secondary tier memory (e.g., memory devices connected over one or more compute express link connections over one or more peripheral component interconnect express (PCIe) buses). The operations of the software layer running in the host processor to move memory pages can significantly degrade the application performance due to the active demotion of cold memory pages to the slower memory, and subsequent accesses to cold memory pages. A memory page that has not been accessed for a period of time can be considered a cold memory page; and the length of a continuous time period in which a memory page has not being access can be an indicator of a temperature of the memory page; a longer length corresponding to a colder page.

Tiering management can be implemented via hardware in the memory system, instead of via a host processor running a software layer. When tiering management is implemented solely in memory hardware, the configuration of the tiered memory cannot be changed without significant changes at different levels in the hardware and software stack.

In general, the bandwidth of a random access memory provided over one or more compute express link (CXL) connections to a host processor can be dependent on several factors: the number of parallel CXL paths between the random access memory and the host processor, the switching topology of a CXL fabric coupled between the random access memory and the host processor, the efficiency of each CXL switch in the CXL fabric, real time traffic load in the CXL fabric, the latency of the memory media, etc.

In some embodiments disclosed herein, a software technique is used to allocate the memory bandwidth required for applications during runtime.

For example, a fabric manager can be configured as a software component running in a CXL fabric (e.g., in a controller of the CXL fabric, or as a set of agents running in the CXL switches of the fabric). A host processor (e.g., a central processing unit (CPU), a graphical processing unit (GPU), a system on a chip (SoC)) connected to the CXL fabric can specify a memory configuration requirement for a random access memory attached via the CXL fabric to the host processor. For example, the memory configuration requirement can specify a requested capacity, a requested bandwidth, and/or a requested latency of the random access memory. The fabric manager can allocate communication resources of the CXL fabric and memory resources of memory devices connected to the CXL fabric to implement a random access memory that has an implemented memory configuration that is closest to the requested memory configuration.

For example, the distance between the implemented memory configuration and the requested memory configuration can be based on a cartesian distance in a memory characteristic space having independent axes in capacity, latency, bandwidth, and/or power efficiency. A requested memory configuration is represented by a point in the memory characteristics space having coordinates represented by the requested capacity, latency, bandwidth, and/or power efficiency. An implemented memory configuration is represented by a point in the memory characteristics space having coordinates represented by the implemented capacity, latency, bandwidth, and/or power efficiency. The cartesian distance between the two points in the memory characteristic space can be minimized or reduced to find an implementation that substantially meets the requirements of the requested memory configuration.

In some implementations, the memory characteristic space is configured based on normalized memory parameters, such as normalized capacity, normalized latency, normalized bandwidth, and/or normalized power efficiency level. For example, the memory characteristic parameters (e.g., capacity, latency, bandwidth, power efficiency level) can be normalized with respect to the corresponding parameters specified in the memory configuration request, or normalized using a set of predetermined parameters (e.g., reference capacity, reference latency, reference bandwidth, reference power efficiency level). Optionally, the normalized parameters can be further weighted according to importance of the respective parameters (e.g., capacity, latency, bandwidth, power efficiency) for the applications running in the host processor.

In some implementations, the fabric manager is configured with a look up table to map the memory addresses identified by the host processor in memory access requests to physical memory addresses of random access memory cells in memory devices connected to the CXL fabric. Through the mapping implemented using the look up table, the memory access requests received in the CXL fabric from the processor can be routed via the CXL fabric to the corresponding memory devices from which the memory resources are allocated to implement the secondary tier random access memory attached to the host processor via the CXL fabric.

Optionally, the fabric manager can continuously or periodically update the look up table used to implement the random access memory attached to the processor to account for runtime variation in memory characteristics such as bandwidth and latency. Optionally, the fabric manager can monitor the deviation of the memory characteristics (e.g., bandwidth, latency) from the requirements specified by the host processor, and update the look up table to reduce or eliminate the differences from the requirements in response to a determination that the deviation exceeds a predefined threshold.

In one implementation, during an initialization phase of attaching the secondary tier memory to a host processor for random access over a CXL fabric, each of the memory devices connected to the CXL fabric can have a small portion of its entire capacity allocated to implement the secondary tier memory. The host processor can run a synthetic workload to determine the observed characterizes (e.g., bandwidth, latency) of each memory allocation. Each memory device connected to the CXL fabric can identify its size of entire capacity to the fabric manager. During the runtime phase of the processor using the random access memory, the memory devices connected to the CXL fabric can send metadata to the fabric manager to indicate the observed latency to the host processor. Based on the measured latency and bandwidth, the fabric manager can adjust the portion sizes of memory resource allocation from the memory devices to implement the random access memory in a way that meets the memory configuration requirement identified the processor and/or reduce the differences between the memory configuration as implemented via the CXL fabric and the memory configuration as requested by the host processor.

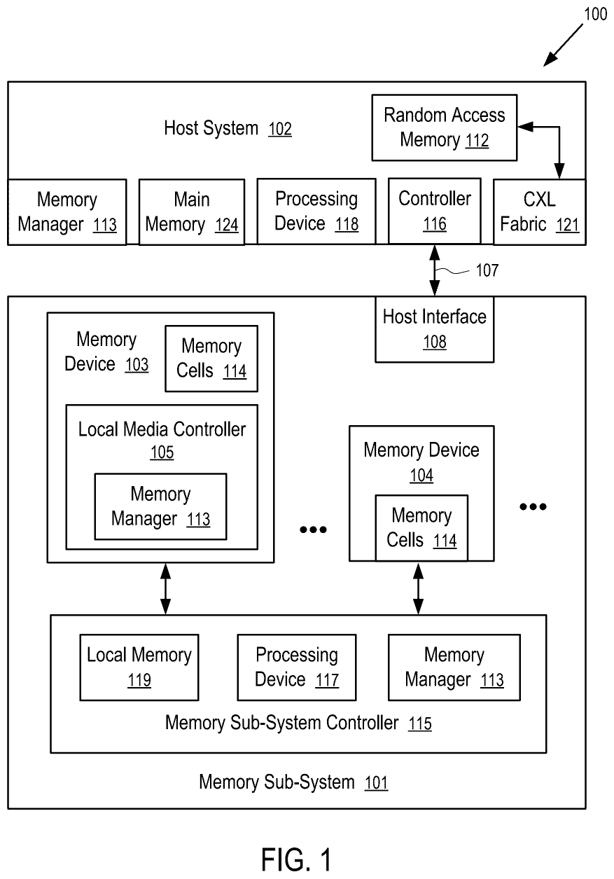

FIG. 1 illustrates an example computing system 100 that includes a memory sub-system 101 in accordance with some embodiments of the present disclosure. The memory sub-system 101 can include media, such as one or more volatile memory devices (e.g., memory device 104), one or more non-volatile memory devices (e.g., memory device 103), or a combination of such.

In general, a memory sub-system 101 can be a storage device, a memory module, or a hybrid of a storage device and memory module. Examples of a storage device include a solid-state drive (SSD), a flash drive, a universal serial bus (USB) flash drive, an embedded multi-media controller (eMMC) drive, a universal flash storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory module (NVDIMM).

The computing system 100 can be a computing device such as a desktop computer, a laptop computer, a network server, a mobile device, a vehicle (e.g., airplane, drone, train, automobile, or other conveyance), an internet of things (IoT) enabled device, an embedded computer (e.g., one included in a vehicle, industrial equipment, or a networked commercial device), or such a computing device that includes memory and a processing device.

The computing system 100 can include a host system 102 that is coupled to one or more memory sub-systems 101. FIG. 1 illustrates one example of a host system 102 coupled to one memory sub-system 101. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

For example, the host system 102 can include a processor chipset (e.g., processing device 118) and a software stack executed by the processor chipset. The processor chipset can include one or more cores, one or more caches, a memory controller (e.g., controller 116) (e.g., NVDIMM controller), and a storage protocol controller (e.g., PCIe controller, SATA controller). The host system 102 uses the memory sub-system 101, for example, to write data to the memory sub-system 101 and read data from the memory sub-system 101.

The host system 102 can be coupled (e.g., over a computer bus 107) to the memory sub-system 101 via a physical host interface 108. Examples of a physical host interface 108 include, but are not limited to, a serial advanced technology attachment (SATA) interface, a peripheral component interconnect express (PCIe) interface, a universal serial bus (USB) interface, a fibre channel, a serial attached SCSI (SAS) interface, a double data rate (DDR) memory bus interface, a small computer system interface (SCSI), a dual in-line memory module (DIMM) interface (e.g., DIMM socket interface that supports double data rate (DDR)), an open NAND flash interface (ONFI), a double data rate (DDR) interface, a low power double data rate (LPDDR) interface, a compute express link (CXL) interface, or any other interface. The physical host interface 108 can be used to transmit data between the host system 102 and the memory sub-system 101. The host system 102 can further utilize an NVM express (NVMe) interface to access components (e.g., memory devices 103) when the memory sub-system 101 is coupled with the host system 102 by the PCIe interface. The physical host interface 108 can provide an interface for passing control, address, data, and other signals between the memory sub-system 101 and the host system 102. FIG. 1 illustrates a memory sub-system 101 as an example. In general, the host system 102 can access multiple memory sub-systems via a same communication connection, multiple separate communication connections, and/or a combination of communication connections.

The processing device 118 of the host system 102 can be, for example, a microprocessor, a central processing unit (CPU), a processing core of a processor, an execution unit, etc. In some instances, the controller 116 can be referred to as a memory controller, a memory management unit, and/or an initiator. In one example, the controller 116 controls the communications over a bus coupled between the host system 102 and the memory sub-system 101. In general, the controller 116 can send commands or requests to the memory sub-system 101 for desired access to memory devices 103, 104. The controller 116 can further include interface circuitry to communicate with the memory sub-system 101. The interface circuitry can convert responses received from the memory sub-system 101 into information for the host system 102.

The controller 116 of the host system 102 can communicate with the controller 115 of the memory sub-system 101 to perform operations such as reading data, writing data, or erasing data at the memory devices 103, 104 and other such operations. In some instances, the controller 116 is integrated within the same package of the processing device 118. In other instances, the controller 116 is separate from the package of the processing device 118. The controller 116 and/or the processing device 118 can include hardware such as one or more integrated circuits (ICs) and/or discrete components, a buffer memory, a cache memory, or a combination thereof. The controller 116 and/or the processing device 118 can be a microcontroller, special purpose logic circuitry (e.g., a field programmable gate array (FPGA), an application specific integrated circuit (ASIC), etc.), or another suitable processor.

The memory devices 103, 104 can include any combination of the different types of non-volatile memory components and/or volatile memory components. The volatile memory devices (e.g., memory device 104) can be, but are not limited to, random access memory (RAM), such as dynamic random access memory (DRAM) and synchronous dynamic random access memory (SDRAM).

Some examples of non-volatile memory components include a negative-and (or, NOT AND) (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 103 can include one or more arrays of memory cells 114. One type of memory cells, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 103 can include one or more arrays of memory cells such as SLCs, MLCs, TLCs, QLCs, PLCs, or any combination of such. In some embodiments, a particular memory device can include an SLC portion, an MLC portion, a TLC portion, a QLC portion, and/or a PLC portion of memory cells. The memory cells 114 of the memory devices 103 can be grouped as pages that can refer to a logical unit of the memory device used to store data. With some types of memory (e.g., NAND), pages can be grouped to form blocks.

Although non-volatile memory devices such as 3D cross-point type and NAND type memory (e.g., 2D NAND, 3D NAND) are described, the memory device 103 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), spin transfer torque (STT)-MRAM, conductive bridging RAM (CBRAM), resistive random access memory (RRAM), oxide based RRAM (OxRAM), negative-or (NOR) flash memory, and electrically erasable programmable read-only memory (EEPROM).

A memory sub-system controller 115 (or controller 115 for simplicity) can communicate with the memory devices 103 to perform operations such as reading data, writing data, or erasing data at the memory devices 103 and other such operations (e.g., in response to commands scheduled on a command bus by controller 116). The controller 115 can include hardware such as one or more integrated circuits (ICs) and/or discrete components, a buffer memory, or a combination thereof. The hardware can include digital circuitry with dedicated (i.e., hard-coded) logic to perform the operations described herein. The controller 115 can be a microcontroller, special purpose logic circuitry (e.g., a field programmable gate array (FPGA), an application specific integrated circuit (ASIC), etc.), or another suitable processor.

The controller 115 can include a processing device 117 (processor) configured to execute instructions stored in a local memory 119. In the illustrated example, the local memory 119 of the controller 115 includes an embedded memory configured to store instructions for performing various processes, operations, logic flows, and routines that control operation of the memory sub-system 101, including handling communications between the memory sub-system 101 and the host system 102.

In some embodiments, the local memory 119 can include memory registers storing memory pointers, fetched data, etc. The local memory 119 can also include read-only memory (ROM) for storing micro-code. While the example memory sub-system 101 in FIG. 1 has been illustrated as including the controller 115, in another embodiment of the present disclosure, a memory sub-system 101 does not include a controller 115, and can instead rely upon external control (e.g., provided by an external host, or by a processor or controller separate from the memory sub-system).

In general, the controller 115 can receive commands or operations from the host system 102 and can convert the commands or operations into instructions or appropriate commands to achieve the desired access to the memory devices 103. The controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory devices 103. The controller 115 can further include host interface circuitry to communicate with the host system 102 via the physical host interface 108. The host interface circuitry can convert the commands received from the host system into command instructions to access the memory devices 103 as well as convert responses associated with the memory devices 103 into information for the host system 102.

The memory sub-system 101 can also include additional circuitry or components that are not illustrated. In some embodiments, the memory sub-system 101 can include a cache or buffer (e.g., DRAM) and address circuitry (e.g., a row decoder and a column decoder) that can receive an address from the controller 115 and decode the address to access the memory devices 103.

In some embodiments, the memory devices 103 include local media controllers 105 that operate in conjunction with the memory sub-system controller 115 to execute operations on one or more memory cells of the memory devices 103. An external controller (e.g., memory sub-system controller 115) can externally manage the memory device 103 (e.g., perform media management operations on the memory device 103). In some embodiments, a memory device 103 is a managed memory device, which is a raw memory device combined with a local controller (e.g., local media controller 105) for media management within the same memory device package. An example of a managed memory device is a managed NAND (MNAND) device.

The controller 115 and/or a memory device 103 can include a memory manager 113 configured to perform operations related to the management of the characteristics of a random access memory 112 attached to the processing device 118 of the host system 102 via a compute express link (CXL) fabric 121. Such characteristics can include capacity, bandwidth, latency, and/or power consumption level. In some embodiments, the controller 115 in the memory sub-system 101 includes at least a portion of the memory manager 113. In other embodiments, or in combination, the fabric 121, the controller 116 and/or the processing device 118 in the host system 102 can include at least a portion of the memory manager 113. For example, the fabric 121, the controller 115, the controller 116, and/or the processing device 118 can include logic circuitry implementing the memory manager 113. For example, the switches and/or controller of the fabric 121, the controller 115, or the processing device 118 (processor) of the host system 102, can be configured to execute instructions stored in memory for performing the operations of the memory manager 113 described herein. In some embodiments, the memory manager 113 is implemented in an integrated circuit chip disposed in the memory sub-system 101 or a controller of the fabric 121. In other embodiments, the memory manager 113 can be part of firmware of the memory sub-system 101, an operating system of the host system 102, a device driver, a set of agents running in CXL switches of the fabric 121, a part of a fabric manager running a controller of the CXL fabric 121, or an application, or any combination thereof.

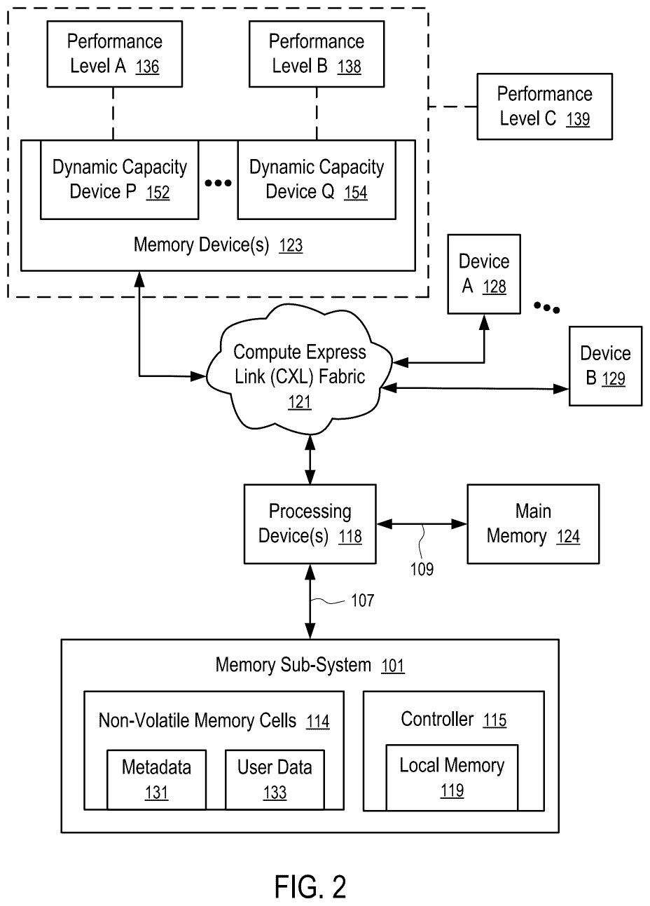

The random access memory 112 can be implemented using resources allocated from a plurality of memory devices 123 attached to the CXL fabric 121 as in FIG. 2 to FIG. 4. For example, the memory devices 123 can offer dynamic capacity devices (e.g., 152, . . . , 154) that can be attached to a host processor (e.g., processing device 118) to provide a secondary tier memory for the host processor to supplement the main memory 124 of the host system 102. The memory manager 113 can be configured to request the dynamic capacity devices (e.g., 152, . . . , 154) to change their capacity sizes a run time to effectively change the characteristics (e.g., capacity, bandwidth, latency, power consumption) of the random access memory 112 functioning as the secondary tier memory. Optionally, the memory manager 113 implemented in the fabric 121 can use a look up table to map addresses used by the processing device 118 in memory access requests into addresses in the memory devices 123. The memory access requests are routed through the fabric 121 according to the look up table/address mapping. The memory manager 113 can change the characteristics (e.g., capacity, bandwidth, latency, power consumption) of the random access memory 112 through dynamically changing the look up table without restarting the computing system 100 and/or the host system 102.

FIG. 2 to FIG. 4 show techniques to provide a secondary tier memory according to some embodiments. For example, the techniques of FIG. 2 to FIG. 4 can be implemented in the computing system 100 of FIG. 1 to provide the random access memory 112 over the CXL fabric 121.

In FIG. 2 to FIG. 4, a compute express link (CXL) fabric 121 is configured to provide a random access memory (e.g., 112) using a set of memory devices 123 having random access memory cells that are addressable using physical memory addresses in the memory devices 123.

For example, the compute express link (CXL) fabric 121 can include a set of CXL switches interconnected via CXL connections and controlled at least in part by a controller. The memory devices 123 are connected to the switches in the fabric 121 via point to point CXL connections; and the controller of the CXL fabric 121 is configured to direct how memory access communications are routed by the CXL switches through the fabric 121 to or from the memory devices 123.

The memory devices 123 can implement a plurality of dynamic capacity devices (e.g., 152, . . . , 154). Each respective dynamic capacity device (e.g., 152, . . . , or 154) can be attached over the CXL fabric 121 to a host processor, such as a processing device 118, or another device 128 or 129. The respective dynamic capacity device (e.g., 152, . . . , or 154) can be implemented by a memory device 123 that implements a plurality of dynamic capacity devices, each attached over the fabric 121 to a different host processor. The respective dynamic capacity device (e.g., 152, . . . , or 154) can determine a maximum amount of memory resources currently available in the memory device 123 and can allocate up to the maximum amount as its capacity. The host processor (e.g., processing device 118 or another device 128 or 129) can determine, in view of the maximum amount, a desired capacity size of the respective dynamic capacity device (e.g., 152, . . . , or 154) that is no larger than the maximum amount. Using a communication protocol according to a standard of compute express link (CXL), the host processor can request the respective dynamic capacity device (e.g., 152, . . . , or 154) to configure itself to have the capacity size identified by the host processor. The respective dynamic capacity device (e.g., 152, . . . , or 154) can effectuate the capacity size change without restarting the memory device 123, the host processor, the host system 102, and/or the computing system 100.

In general, the memory devices 123 can service, via their connections to the fabric 121, multiple host processors, such as processing device 118 (e.g., central processing unit (CPU), system on a chip (SoC)), and other devices 128, . . . , 129 (e.g., artificial intelligence (AI) accelerator, graphical processing unit (GPU), network interface card). A subset of the dynamic capacity devices 152, . . . , 154 offered by the memory devices 123 can be attached to one host processor; and one or more other subsets can be attached to one or more other host processors.

Due to the differences in the memory devices 123 and/or the locations of the memory devices 123 in the network of CXL connections in the fabric 121, the dynamic capacity devices 152, . . . , 154 offered by the different memory devices 123 can have different performance levels 136, . . . , 138 in bandwidth, latency, and/or power consumption. Different combinations of capacity sizes of the dynamic capacity devices 152, . . . , 154 attached to a host processor (e.g., processing device 118, device 128 or 129) can lead to differently implemented performance levels 139 of the random access memory 112 for the host processor.

In one implementation, a memory manager 113 running in the host processor is configured to determine the desired capacity sizes of the dynamic capacity devices 152, . . . , 154 attached to the host processor such that the performance level 139 of the random access memory 112 attached via the fabric 121 to the host processor meets, or matches with, the current requirements of one or more applications running in the host processor. As the runtime status of the applications changes, the current requirements can change; and in response, the host processor can request the dynamic capacity devices 152, . . . , 154 to change their capacity sizes such that the performance level 139 of the random access memory 112 meets, or matches with, the current requirements.

In another implementation, the host processor communicates its memory requirements to a controller of the CXL fabric 121. The memory manager 113 running in the controller can request the dynamic capacity devices 152, . . . , 154 to change their capacity sizes on behalf of the host processor such that the performance level 139 of the random access memory 112 attached to the host processor satisfies, or approximately matches with, the current requirements.

In general, the performance level 139 of the random access memory 112 attached over the fabric 121 to the host processor can change in response to the communications workload applied to the fabric 121 and/or the memory access workload applied to the memory devices 123. The memory manager 113 (e.g., running in the host processor or in the controller of the fabric 121) can monitor the runtime performance level 139 of the random access memory 112 and request the dynamic capacity devices 152, . . . , 154 to change their capacity sizes such that the runtime performance level 139 of the random access memory 112 satisfies, or approximately matches with, the current requirements of the host processor.

Optionally, the memory devices 123 may not offer dynamic capacity devices for attaching to a host processor. Instead, the controller of the compute express link fabric 121 can offer a dynamic capacity device attachable to each host processor. The controller can dynamically allocate memory resources from the memory devices 123 to implement the dynamic capacity device such that the performance level 139 of the random access memory 112 provided via the dynamic capacity device offered by the controller satisfies, or approximately matches with, the current requirements of the host processor.

Optionally, the memory devices 123 offer dynamic capacity devices 152, . . . , 154 that are attached to the controller of the compute express link fabric 121. The controller in turn offers a dynamic capacity device attachable to a host processor. The controller uses a subset of the dynamic capacity device 152, . . . , 154 offered by the memory devices 123 to implement the dynamic capacity device offered by the controller over the fabric 121 to the host processor. The controller can dynamically adjust the capacity sizes of the dynamic capacity devices (e.g., 152, 154) in the subset such that the performance level 139 of the random access memory 112 provided via the dynamic capacity device offered by the controller satisfies, or approximately matches with, the current requirements of the host processor.

In FIG. 2, a main memory 124 is connected to a host processor (e.g., the processing device(s) 118) via a memory bus 109 (e.g., a double data rate (DDR) bus); and a memory sub-system 101 (e.g., as in FIG. 1) is connected to the processing device(s) using a peripheral bus 107 (e.g., a peripheral component interconnect express (PCIe) bus) that is different and separate from the memory bus 109. The main memory 124 is the primary tier memory of the host processor; and the random access memory 112 provided over the CXL fabric 121 and implemented using the dynamic capacity devices 152, . . . , 154 is the secondary tier memory of the host processor.

Optionally, a memory controller 116 (e.g., configured in the host processor) can manage the placement and movement of memory pages between the primary tier memory and the secondary tier memory. For example, applications running in the host processor (e.g., processing device 118) can use virtual memory addresses to access a page of memory. The page can be physically in the primary tier memory or in the secondary tier memory. When a page currently in the primary tier memory has not been used for more than a threshold length of time period, the memory controller 116 can move the page to the secondary tier memory and thus free up memory resources previously used by the page in the primary tier memory. The freed memory resources can then be used for a more frequently and/or recently accessed memory page.

When memory pages accessed by the applications are all in the primary tier memory, the memory controller 116 can decide that it is not necessary to have a large secondary tier memory; and a memory manager 113 in the memory controller 116 can request the dynamic capacity devices (e.g., 152, 154) that are attached to the host processor (e.g., processing device 118) and/or the memory controller 116 to reduce their capacity sizes. Reducing the capacity sizes of the dynamic capacity devices (e.g., 152, 154) in the memory devices 123 frees up resources in the memory devices 123 such that other dynamic capacity devices can increase their capacity sizes to service other host processors (e.g., devices 128, 129).

When memory pages accessed by the applications exceed the capacity of the primary tier memory, the memory controller 116 can decide to swap some pages from the primary tier memory to the secondary tier memory. When the current capacity size of the random access memory 112 in the secondary tier memory is insufficient, the memory controller 116 can request one or more of the dynamic capacity devices (e.g., 152, 154) that are attached to the host processor (e.g., processing device 118) and/or the memory controller 116 to increase their capacity sizes, in view of the current availability of memory resources in the memory devices 123.

When the activities of swapping pages between the primary tier memory and the secondary tier memory increase, the memory controller 116 can determine that the bandwidth and/or latency of the secondary tier memory limits the performance of the applications running in the host processor. Thus, the memory controller 116 can request one or more of the dynamic capacity devices (e.g., 152, 154) that are attached to the host processor (e.g., processing device 118) and/or the memory controller 116 to change their capacity sizes in a way to increase the performance level 139 of the random access memory 112 in the secondary tier memory.

When the activities of swapping pages between the primary tier memory and the secondary tier memory decrease, the memory controller 116 can decide that the current performance level in bandwidth and/or latency of the secondary tier memory can be excessive in view of the reduced performance demand of the applications running in the host processor. Thus, the memory controller 116 can request one or more of the dynamic capacity devices (e.g., 152, 154) that are attached to the host processor (e.g., processing device 118) and/or the memory controller 116 to change their capacity sizes in a way to decrease the performance level 139 of the random access memory 112 in the secondary tier memory, which can free up resources in the memory devices 123 for use by other host processors (e.g., devices 128, 129).

Thus, the capacity, bandwidth, latency, and/or power consumption levels of the random access memory 112 in the secondary tier memory, attached over the fabric 121 to the host processor (e.g., processing device 118) and implemented using random access memory cells in the memory devices 123, can change in view of the real time memory activities and demands of the applications running in the host processor.

Alternatively, the memory controller 116 can be configured to send the memory configuration requirements (e.g., capacity, bandwidth, latency, and/or power consumption) to the controller of the fabric 121 to cause the controller to adjust the implementation of the secondary tier memory without restarting the host processor, the host system 102, and/or the computing system 100.

Optionally, the memory controller 116 can be configured to use at least a portion of the main memory 124 as a cache memory for accessing the random access memory 112 in the secondary tier memory.

In some implementations, a portion of the memory of the host system 102 as a whole, including the main memory 124 in the primary tier memory of the processing devices 118 and the random access memory 112 in the secondary tier memory, can be allocated to support the operations of the memory sub-system 101.

For example, a portion of the memory can be allocated as a host memory buffer (HMB) of the memory sub-system 101. The host memory buffer can be used to buffer a portion of a logical to physical translation table of the memory sub-system 101.

The memory sub-system 101 can use its non-volatile memory cells 114 (e.g., NAND memory) for persistent storage of metadata 131, such as the logical to physical translation table. The storage capacity of the memory cells 114 is used to store both user data 133 and the metadata 131 about the storage of the user data 133.

Accessing the non-volatile memory cells 114 for address translation computations can be slower than accessing the host memory buffer. To improve the speed of address translation operations, the memory manager 113 in the memory sub-system 101 can load an actively used portion of the logical to physical translation table into its local memory 119, and load another portion of the logical to physical translation table that is likely to be used into the host memory buffer. Such an arrangement can reduce the need to read and write the non-volatile memory cells 114 to use and update the logical physical translation table and thus improve the overall performance of the memory sub-system 101 in providing its storage services. Optionally, the memory sub-system 101 can use a portion of the logical to physical translation table in the host memory buffer directly in address translation without loading the portion into the local memory 119.

When the workload for the memory sub-system 101 changes, the memory demand (e.g., resources need for the host memory buffer) can change. The memory manager 113 can adjust the performance level 139 and/or the capacity size of the secondary tier memory based on the memory demand of the memory sub-system 101.

In some implementations, the memory sub-system 101 can access, over the CXL fabric 121, the host memory buffer in the memory devices 123 without going through and/or without assistance from the processing devices 118 connected to the main memory 124, as in FIG. 3

In FIG. 3, a set of bus connections 137 can interconnect the peripheral bus 107 (e.g., a peripheral component interconnect express (PCIe) bus), the memory bus 109 (e.g., a double data rate (DDR) bus) and the CXL fabric 121. The memory sub-system 101 is configured with a direct memory access (DMA) engine 135 operable to access the memory in the host system 102, including the main memory 124 and the random access memory (e.g., 112) implemented using the memory devices 123 connected via the fabric 121.

Using the DMA engine 135 the memory manager 113 of the memory sub-system 101 can copy a portion of the logical physical translation table from the local memory 119 to the host memory buffer in the memory devices 123. Thus, the local memory 119 can be freed for storing another portion of the logical to physical translation table for active use, or for other memory usages.

For example, the memory sub-system 101 can retrieve a portion of the logical to physical translation table from the non-volatile memory cells 114 into the local memory 119 and then copy the portion to the host memory buffer (e.g., for buffering/caching, and/or for reference in address translation).

For example, the memory sub-system 101 can store a portion of the logical to physical translation table in the local memory 119 for active address translation operations. When subsequent operations do not use the portion for a period of time, the memory sub-system 101 can offload the portion to the host memory buffer for buffering and to load another portion of the logical to physical translation table (e.g., from the host memory buffer, or the memory cells 114) for active use.

When a portion of the logical physical translation table in the host memory buffer is to be used actively, the DMA engine 135 can fetch the portion of the logical physical translation table from the host memory buffer into the local memory 119 without assistance from the processing device(s) 118.

In some implementations, the DMA engine 135 and/or the memory sub-system 101 can function as a host of the main memory 124 and/or the random access memory (e.g., 112) implemented using the memory devices 123 connected via the fabric 121. Thus, the memory sub-system 101 can configure a portion of the local memory 119 as a cache memory for accessing the random access memory (e.g., 112) implemented using the memory devices 123 connected to the fabric 121, including the host memory buffer.

In some implementations, the connection 107 to the memory sub-system 101 is also a compute express link (CXL) connection to the fabric 121, as in FIG. 4.

When the memory sub-system 101 is connected to the fabric 121 via a compute express link (CXL) connection, the memory sub-system 101 and/or a direct memory access (DMA) engine in the memory sub-system 101 can use the random access memory (e.g., 112) implemented using the memory devices 123 connected via the fabric 121 in a way similar to the processing device(s) 118 using the random access memory (e.g., 112). The memory sub-system 101 can dynamically allocate a portion of the random access memory (e.g., 112) as its host memory buffer to store the entire logical to physical translation table or a portion of it, without assistance from the processing device(s) 118 connected to the main memory 124.

In some implementations, when the memory sub-system 101 is connected to the fabric 121 via a compute express link (CXL) connection, a controller of the CXL fabric 121 can use the storage space of the non-volatile memory cells 114 to provide a logical memory device (e.g., a dynamic capacity device) having a memory space of random access memory accessible by various hosts connected to the fabric 121, such as the processing device(s) 118 and other devices 128, . . . , 129 (e.g., artificial intelligence (AI) accelerator, graphical processing unit (GPU)), as further discussed below. Thus, the devices (e.g., 118, 128, 129) connected to the fabric 121 can virtually access the memory sub-system 101 over the fabric 121 as if the storage space of the memory sub-system 101 (e.g., the capacity of the non-volatile memory cells 114) were random access memory.

Different portions of the capacity of a storage device (e.g., solid-state drive) are typically configured to be addressed for access using logical block addressing (LBA) addresses. Each LBA address represents a predetermined amount of capacity (e.g., 512 bytes, 4 KB), which is significantly larger than the capacity represented by a memory address for accessing a random access memory.

Different portions of a random access memory (e.g., 112, main memory 124) are typically configured to be addressed for access using memory addresses. Each memory address represents a predetermined amount of capacity (e.g., one byte, eight bytes, or 128 bytes), which is significantly smaller than the capacity of an LBA address for accessing a storage device.

Communication protocols for accessing via LBA addresses and for accessing via memory addresses are typically adapted differently to accommodate typical patterns of accessing: large chunks of data accessed via LBA addresses and small chunks of data accessed via memory addresses.

For example, when a large chunk of data is accessed via an LBA address, it is possible to use a relatively large amount of communication overhead to implement enhanced features without significantly degrading the system performance. In contrast, when a small chunk of data is accessed via a memory address, an increase in communication overhead can significantly degrade the system performance. Thus, block-based storage devices and random access memory devices are typically not interchangeable in their usages in a computing system.

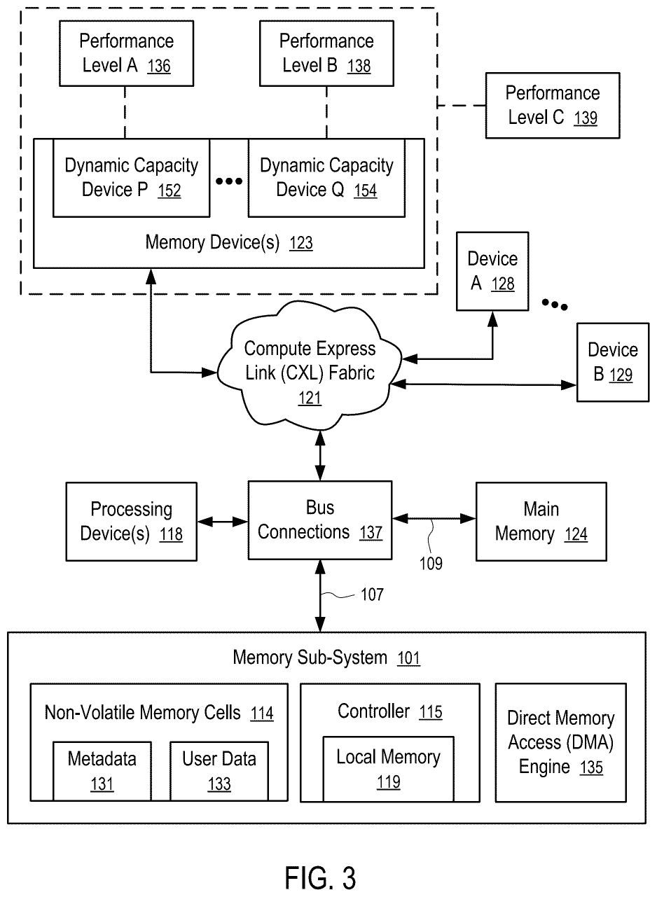

FIG. 5 shows a compute express link fabric configured to provide a secondary tier memory according to one embodiment. For example, the compute express link fabric 121 discussed above in connection with FIG. 1 to FIG. 4 can be implemented as in FIG. 5.

In FIG. 5, the compute express link fabric 121 includes a plurality compute express link switches (e.g., 221, 223, 225). Each of the switches (e.g., 221, 223, or 225) has a plurality of ports connected to separate compute express link connections. A switch (e.g., 221, 223, or 225) is configured to route a memory access request or response received at one port to another. A compute express link connection in the fabric 121 can connect a port of one switch to a port of another switch, or to a memory device (e.g., 141, 143, or 145), or to a memory sub-system (e.g., 161, or 163), or to a host processor, such as a processing device 118 (e.g., a CPU, a CPU core, an SoC) or another device (e.g., 128 or 129, such as a GPU, a GPU core, an AI accelerator).

A controller 122 of the fabric 121 can control the switches (e.g., 221, 223, or 225) of the fabric 121 to implement a look up table or address mapping 165 for routing memory access requests having addresses specified by a host processor (e.g., processing device 118, or device 128 or 129) into addresses of random access memory cells in the memory devices 141, 143, . . . , 145.

The controller 122 can include a fabric manager and/or a memory manager 113 to adjust the mapping 165 for implementing a random access memory 112 in a secondary memory tier using memory resources in the memory devices 141, 143, . . . , 145, with or without the use of techniques of dynamic capacity devices (e.g., 152, 154) offered by the memory devices 141, 143, . . . , 145. Optionally, the memory resources are provided by the memory devices 141, 143, . . . , 145 in the form of dynamic capacity devices (e.g., 152, . . . , 154) attached to the controller 122 over the fabric 121. Alternatively, the memory resources can be provided by the memory devices 141, 143, . . . , 145 via random access memory cells addressable by the controller 122 without the use of the dynamic capacity devices offered by the memory devices 141, 143, . . . , 145; and thus, the techniques can be used even when the memory devices 141, 143, . . . , 145 do not implement the functions and protocols of dynamic capacity devices.

In some implementations, the memory manager 113 (and/or the fabric manager) is configured on a centralized device in communication with the switches 221, 223, . . . , 225 in the fabric 121. In other implementations, the memory manager 113 (and/or the fabric manager) is implemented via a set of agents each running in one of the switches 221, 223, . . . , 225. The agents can be configured to make separate and independent routing decisions. The agents can collectively implement the operations of the controller 122 by each routing memory access traffic from one port of a switch to another port of the same switch in which the agent is running.

The controller 122 of the compute express link fabric 121 (e.g., as discussed above in connection with FIG. 1 to FIG. 4) can monitor the changing memory/storage usage patterns and/or the real time performance level 139 of a random access memory 112 in the secondary tier memory of a host processor (e.g., device 118, 128, or 129). When the real time performance level 139 deviates from a requirement from the host processor, the controller 122 can change the mapping 165 at the run time such that the performance level 139 of the random access memory 112 in the secondary tier memory meets, or matches with, the performance requirement specified by the host processor (e.g., processing device 118, or device 128 or 129).

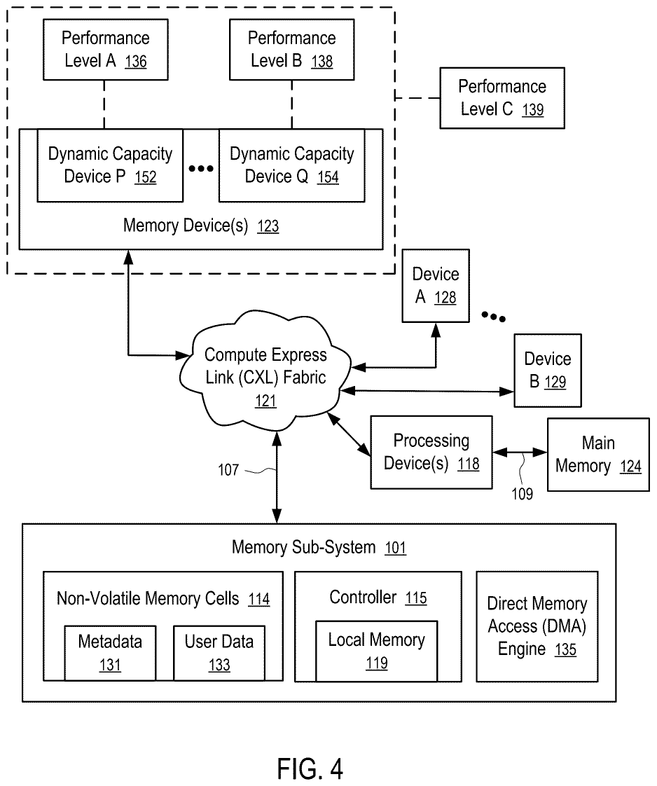

FIG. 6 shows the attaching of dynamic capacity devices over a compute express link fabric to provide a random access memory according to one embodiment. For example, the random access memory 112 in the secondary tier memory of a host processor 106 (e.g., processing device 118, or device 128 or 129) in a computing system 100 of FIG. 1 can be implemented via attaching dynamic capacity devices as in FIG. 6 over a compute express link fabric 121 configured as in FIG. 2 to FIG. 5.

In FIG. 6, the host processor 106 has a main memory 124 that is connected to the host processor 106 via a memory bus 109 to provide a primary tier memory of the host processor 106.

Further, the host processor 106 can have a random access memory 112 in a secondary tier memory that is implemented via a plurality of memory devices (e.g., 141, . . . , 143) connected over a compute express link fabric 121.

Each of the memory devices (e.g., 141, 143) can offer a plurality of dynamic capacity devices (e.g., 151, 153, . . . ; 155, . . . ). At least one of the dynamic capacity devices (e.g., 151, 153, . . . ) of a memory device 141 can be attached over the compute express link fabric 121 to the host processor 106. For example, during a boot up process, the operation of attaching 209 some dynamic capacity devices (e.g., 151, . . . , 155) to the host processor 106 is performed. For example, a dynamic capacity device (e.g., 151, or 155) attached to the host processor 106 can be configured for exclusive use by the host processor 106; and other host processors are prevented from accessing, over the CXL fabric 121, the dynamic capacity device (e.g., 151, or 155) attached to the host processor 106.

For example, a dynamic capacity device 151 of the memory device 141 is attached to the host processor 106 to implement a portion of the random access memory 112, where the size of the portion is adjustable via adjusting the capacity size of the dynamic capacity device 151; and a dynamic capacity device 155 of the memory device 143 is attached to the host processor 106 to implement another portion of the random access memory 112, where the size of the portion is adjustable via adjusting the capacity size of the dynamic capacity device 155.

Each of the dynamic capacity devices (e.g., 151, 155) can have a capacity size that is dynamically requested by the host processor 106. A memory device (e.g., 141) is configured to dynamically allocate memory resources within the memory device (e.g., 141) to satisfy the capacity size request from the host processor 106. The capacity size of the random access memory 112 is the sum of the capacity sizes of the dynamic capacity devices 151, . . . , 155 attached to the host processor 106. To access a location in the random access memory 112, the host processor 106 identifies a dynamic capacity device (e.g., 151) and a memory address within the current capacity size of the dynamic capacity device (e.g., 151).

For example, the host processor 106 can cause the random access memory 112 to be implemented using memory resources from the memory device 141 but not memory resources from other memory devices (e.g., 143) by requesting the dynamic capacity device 151 to have a capacity size that is equal to the capacity size of the random access memory 112, and requesting the other dynamic capacity devices (e.g., 155) attached to the host processor 106 to have capacity sizes equal to zero. As a result, the characteristics (e.g., bandwidth, latency, power consumption) of the random access memory 112 are determined by the memory device 141 and its position in the fabric 121 relative to the host processor 106.

For example, the host processor 106 can cause the random access memory 112 to be implemented using memory resources from the memory devices 141 and 143 but not memory resources from other memory devices by requesting the dynamic capacity devices 151 and 155 to have capacity sizes that are larger than zero, and requesting the other dynamic capacity devices attached to the host processor 106 to have capacity sizes equal to zero. As a result, the capacity size of the random access memory 112 is equal to the sum of the capacity sizes of the dynamic capacity devices 151 and 155; and the characteristics (e.g., bandwidth, latency, power consumption) of the random access memory 112 are determined by the memory devices 141 and 143, the ratio of their capacity sizes, and their positions in the fabric 121 relative to the host processor 106.

The host processor 106 can request changes in the capacity sizes of the dynamic capacity devices 151, . . . , 155 attached to the host processor 106 without a need to restart the host processor 106, the memory devices 141, . . . , 143, and/or the computing system 100 containing the host processor 106 and the memory devices 141, . . . , 143.

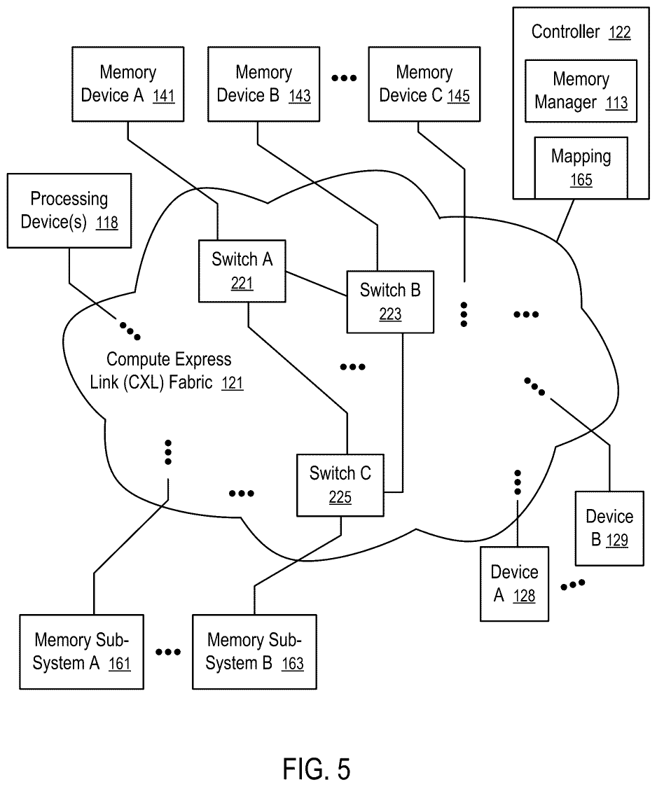

FIG. 7 shows a mapped memory space implemented via a compute express link fabric to provide a dynamically adjustable random access memory according to one embodiment. For example, the random access memory 112 of FIG. 1 provided over a compute express link fabric 121 can be implemented using a mapped memory space 171 and a controller 122 of the fabric 121.

In FIG. 7, the mapped memory space 171 is implemented via the controller 122 of the compute express link (CXL) fabric 121 connecting a plurality of memory devices 141, 143, . . . , 145 having random access memory cells (e.g., as in FIG. 2 to FIG. 6).

A host processor (e.g., 106) can be a processing device 118, or another device (e.g., 128, or 129 in FIG. 2 to FIG. 5). The host processor 106 can send a memory access request using a memory address in the mapped memory space 171 to access the random access memory 112 connected to the host processor 106 via the fabric 121.

A memory region 174 of the mapped memory space 171 can correspond to the random access memory 112 in a secondary tier memory of the host processor 106.

For example, the controller 122 can offer a dynamic capacity device 152 that has a set of memory addresses in the memory region 174. During a boot up process, the dynamic capacity device 152 is attached to the host processor 106. When the host processor 106 accesses the memory addresses in the dynamic capacity device 152, the controller 122 maps the memory access requests to one or more portions in the memory devices 141, 143, . . . , 145 connected to the fabric 121. Thus, the memory devices 141, 143, . . . , 145 do not have to implement the functions and protocols of dynamic capacity devices; and the dynamic capacity device 152 can be implemented, via the controller 122 mapping 165 memory addresses in the memory region 174 to the memory devices 141, 143, . . . , 145, using the memory resources allocated from one or more of the memory devices 141, 143, . . . , 145.

Since the memory region 174 is formulated based on the identity of the dynamic capacity device 152, the size of the memory region 174 can change dynamically without impacting the usages of memory regions allocated for other uses.

For example, the mapped memory space 171 can have memories 173, . . . , 175 allocated respectively for the memory sub-systems 161, . . . , 163, such as submission queues 181, 185 for the memory sub-systems 161, 163 to obtain commands for execution, and completion queues 183, 187 for the memory sub-systems 161, 163 to provide completion records after execution of the commands. For example, the queues (e.g., 181, 183, 185, 187) can be used to facilitate communications with the memory sub-systems 161, . . . , 163 for storage access (e.g., according to a non-volatile memory express (NVMe) standard).

For example, a memory sub-system (e.g., 161) is allowed to retrieve commands from its submission queues (e.g., 181) but not allowed to retrieve commands from submission queues (e.g., 185) configured for other memory sub-systems (e.g., 163). Similarly, a memory sub-system (e.g., 161) is allowed to enter completion messages into its submission queues (e.g., 183) but not allowed to enter messages into completion queues (e.g., 185) configured for other memory sub-systems (e.g., 163).

The host processor 106 can send commands (e.g., read commands, write commands) to a memory sub-system (e.g., 161, or 163) by entering the commands in a submission queue (e.g., 181 or 185) configured for the memory sub-system (e.g., 161, or 163). For example, the processing device(s) 118 of the host system 102 can write a command into the submission queue 181 (e.g., in accordance with a NVMe standard); and the memory sub-system 161 can subsequently retrieve the command from the submission queue 181 (e.g., in accordance with the NVMe standard) for execution.

Optionally, the memory 173 (or 175) can be encapsulated in another dynamic capacity device offered by the controller 122 such that the capacity of the memory 173 can increase or decrease dynamically without a need for restarting.

Optionally, the mapped memory space 171, implemented according to mapping 165 in the controller 122, can have different portions allocated as host memory buffers for the memory sub-systems 161, . . . , 163.

In some implementations, a submission queue (e.g., 181) in the mapped memory space 171 is reserved for the controller 122 of the compute express link fabric 121 to send commands to operate the respective memory sub-system (e.g., 161).

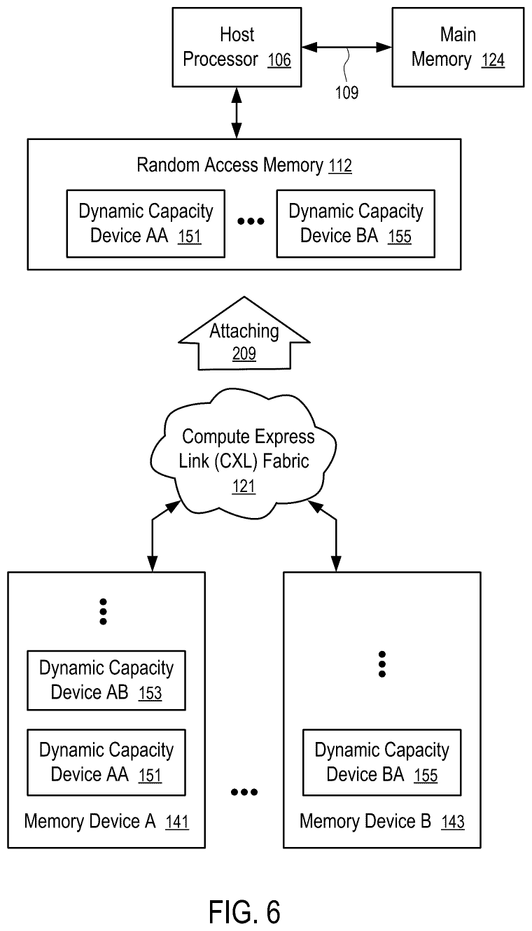

For example, the controller 122 can use a portion of the memory space 171 to cache a portion of the memory sub-system 161 (e.g., as illustrated in FIG. 8) via sending commands to the memory sub-system (e.g., 161) via the submission queue (e.g., 181) without assistance from the host processor 106. Thus, the host processor 106 can access the cached portion of the memory sub-system 161 without the need to send storage access commands to the memory sub-system (e.g., 161) using a submission queue. The controller 122 can generate the storage access commands for the host processor 106 in response to the memory access requests received in the fabric 121 from the host processor 106. Such a cached portion can be included in the memory region 174; and using such a technique, the controller 122 can also use a portion of the memory sub-system 161 to implement the persistent storage of data (e.g., 177) in at least a portion of the dynamic capacity device 152.

Thus, the dynamic capacity device 152 attached as at least a portion of the random access memory 112 in the secondary memory tier of the host processor 106 can be implemented using not only the memory resources in the memory devices 141, 143, . . . , 145 that have random access memory cells accessible via memory access protocols, but also the storage resources of the memory sub-systems 161, . . . , 163 that are configured to be accessed via storage access protocols.

For example, when a portion of the random access memory 112 used by an application running in the host processor 106 becomes cold (e.g., have not been used for a time period longer than a threshold and/or is predicted to be not used for a time period longer than a threshold), the controller can store the data (e.g., 177) of such a portion into a memory sub-system (e.g., 161 or 163) and update the mapping 165 to indicate that the data 177 of the portion of the memory region 174 is currently residing in the memory sub-system (e.g., 161 or 163). As a result, the corresponding portion of random access memory cells in the memory devices 141, 143, . . . , 145 can be freed and/or reallocated for use in a more memory-demanding application and/or by a more memory-demanding host processor.

Optionally, the host processor 106 can enter a read command in the submission queue 185 configured for the memory sub-system 163. After the memory sub-system 163 retrieves the read command from the submission queue 185, the memory sub-system 163 can execute the read command to retrieve data (e.g., 177) from its storage medium (e.g., non-volatile memory cells 114) and write the data (e.g., 177) to a memory address identified in the read command. For example, the memory address can be used to identify a location in the mapped memory space 171. Alternatively, the memory address can be used to identify a location in the main memory 124. For example, a direct memory access (DMA) engine (e.g., 135 in FIG. 3 or FIG. 4) of the memory sub-system 163 can send the data (e.g., 177) to the memory address identified in the read command without assistance from the host processor 106.

Optionally, the host processor 106 can enter a write command in the submission queue 181 configured for the memory sub-system 161. After the memory sub-system 161 retrieves the write command from the submission queue 181, the memory sub-system 161 can execute the write command by retrieving data (e.g., 177) from a memory address identified in the write command and programming its storage medium (e.g., non-volatile memory cells 114) to store the data (e.g., 177). For example, the memory address can be used to identify a location in the mapped memory space 171. Alternatively, the memory address can be used to identify a location in the main memory 124. For example, a direct memory access (DMA) engine (e.g., 135 in FIG. 3 or FIG. 4) of the memory sub-system 161 can load the data (e.g., 177) from the memory address identified in the write command without assistance from the host processor 106.

Optionally, the controller 122 can offer to attach a plurality of dynamic capacity devices 152, . . . , 154 to the host processor 106 during the boot time of the computing system 100. Each of the dynamic capacity devices 152, . . . , 154 can offer a variable capacity size and a dynamically adjustable performance level for a segment of the random access memory 112 implemented using the dynamic capacity devices 152, . . . , 154. The controller 122 can use the mapping 165 to route, via the compute express link fabric 121, memory access requests addressing the dynamic capacity devices 152, . . . , 154 to physical addresses of random access memory cells in the memory devices 141, 143, . . . , 145. Thus, different segments of the random access memory 112 can have different nominal performance levels. Optionally, the dynamic capacity devices 152, . . . , 154 can be implemented respectively using separate dynamic capacity devices (e.g., 151, . . . , 155) offered by the memory devices (e.g., 141, . . . , 143).

Alternatively, the random access memory 112 of the host processor 106 is implemented using a single dynamic capacity device 152 offered by the controller 122 and implemented using the memory resources of the memory devices 141, 143, . . . , 145 and/or the memory sub-systems 161, . . . , 163.

FIG. 8 illustrates a controller of a compute express link (CXL) fabric caching portions of memory sub-systems in the memory space provided by memory devices connected to the fabric according to one embodiment.

In FIG. 8, the memory sub-systems 161, . . . , 163 can be attached to a host system 102 having a compute express link (CXL) fabric 121 as in FIG. 2 to FIG. 7. Each of the memory sub-systems 161, . . . , 163 can be implemented in a way as in FIG. 1. The controller 122 of the fabric 121 can implement the mapped memory space 171 using the random access memory cells in the memory devices 141, 143, . . . , 145 connected to the CXL fabric 121.

For example, a memory sub-system 161 can have a storage space 231 addressable via logical block addressing (LBA) addresses using storage access commands. A portion of the storage space 231 can be cached in the mapped memory space 171 as a cached portion 232 that is physically mapped to one or more portions in the memory devices (e.g., 141, 143, and/or 145) connected to the fabric 121, in a way similar to the memory region 174 corresponding to a dynamic capacity device 152 being mapped and implemented using portions of the memory devices 141, 143, . . . , 145 connected to the fabric 121.

Similarly, a storage space 233 in the memory sub-system 163 can have a portion cached as a cached portion 234 in the mapped memory space 171. The cached portion 234 can be implemented using portions of the memory devices 141, 143, . . . , 145, in a way similar to the implementation of dynamic capacity device 152.

A host processor 106 (e.g., processing device 118 or another device 128 or 129) can optionally access the memory sub-systems 161, . . . , 163 via entering storage access commands into the submission queues (e.g., 181, 185) configured for the memory sub-systems 161, . . . , 163, or send memory access commands to the fabric 121 using memory addresses of the cached portions (e.g., 232, 234).

In some implementations, a cached portion (e.g., 232, or 234) is part of the memory region 174 (e.g., in FIG. 7) corresponding to the dynamic capacity device 152 to implement the random access memory 112 in the secondary tier memory of the host processor 106.

Optionally, the controller 122 can be configured to present the entire storage space 231 of the memory sub-system 161 as a cached portion 232 in the mapped memory space 171 such that a host processor 106 (e.g., the processing device 118, or device 128 or 129) can use the storage space 231 without using storage access commands and without using submission queues (e.g., 181) configured for the memory sub-system 161. Thus, the submission queues (e.g., 181) configured for the memory sub-system 161 can be reserved for exclusive use by the controller 122 in implementing the cached portion 232. The host processor 106 can access the cached portion 232 using memory access requests instead of storage access commands.

For example, the controller 122 can be configured to present (e.g., to the processing device(s) 118 and other devices 128, . . . 129 connected to the fabric 121) the entire storage space 231 of the memory sub-system 161 as a portion of a random access memory in the mapped memory space 171, as if the memory sub-system 161 were a random access memory device. For example, the storage space 231 can have a capacity larger than the combined random access memory capacity of the memory devices 141, 143, . . . , 145; and thus, the mapped memory space 171 can be larger than the combined random access memory capacity of the memory devices 141, 143, . . . , 145. The controller 122 can configure its mapping 165 to map an actively used portion of the storage space 231 as a cached portion 232 that is currently mapped into portions of the memory devices 141, 143, . . . , 145, while other portions of the storage space 231 as mapped to the memory space 171 are not concurrently implemented using the random access memory in the memory devices 141, 143, . . . , 145. The memory space 171 implemented using the storage space 231 can be actually implemented using the memory devices 141, 143, . . . , 145 one portion at time. Thus, the portion of the memory space 171 implemented using the storage space 231 can have persistent storage in the memory sub-system 161, while an actively used portion of the storage space 231 is implemented (e.g., mirror or cached) in the memory devices 141, 143, . . . , 145.

For example, when the host processor 106 requests accesses to memory addresses in the mapped memory space 171 that correspond to a portion of the storage space 231, the controller 122 can determine a corresponding LBA address of the portion. If the storage space represented by the LBA address is not already cached or mirrored in the memory space 171 using random access memory of the memory devices 141, 143, . . . , 145, the controller 122 can dynamically allocate one or more portions from the memory devices 141, 143, . . . , 145, enter a read command in the submission queue 181 configured for the memory sub-system 161 to retrieve the data at the LBA address into the cached portion 232 implemented using the dynamically allocated portions of the memory devices 141, 143, . . . , 145, and route the memory access requests from the processing device(s) 118 over the fabric 121 to the memory devices 141, 143, . . . , 145.

When the controller 122 determines that the cached portion 232 is not likely to be accessed by the processing device(s) 118 in a subsequent period of time and the content of the cached portion 232 has not yet been committed into the storage space 231, the controller 122 can enter a write command in the submission queue 181 to write the data of the cached portion 232 into the memory sub-system 161. Upon receiving a completion message in the completion queue 183 that indicates the completion of the write command, the controller 122 can free the random access memory allocated from the memory devices 141, 143, . . . , 145 to implement the cached portion 232, which can then be reused to implement another cached portion of the storage space 231 of the memory sub-system 161, or a cached portion 234 of the storage space 233 of another memory sub-system 163.

Thus, the controller 122 can effectively provide a mapped memory and storage service for devices (e.g., 118, 128, 129) connected to the compute express link (CXL) fabric 121 through the use of mapping 165 to route memory access requests to the memory devices 141, 143, . . . , 145 over the CXL fabric 121 and the use of the submission queues (e.g., 181, 185) and completion queues (e.g., 183, 187) to operate the memory sub-systems 161, . . . , 163. The devices (e.g., 118, 128, 129) can access the storage spaces 231, . . . , 233 of the memory sub-systems 161, . . . , 163 via the memory devices 141, 143, . . . , 145 that are dynamically mapped by the controller 122 as proxies. Since the tasks of using message queues (e.g., 181, 183, 185, 187) to communicate with memory sub-systems (e.g., 161, 163) are offloaded to the controller 122 of the CXL fabric 121, the complexity of routines and applications running in the processing devices (e.g., 118, 128, 129) can be reduced.

Optionally, the storage spaces 231, . . . , 233 of the memory sub-systems 161, . . . , 163 can be used to implement part of the dynamic capacity devices (e.g., 152, 154) attached by the controller 122 to host processors (e.g., 106).

Optionally, the controller 122 can dynamically adjust the mapping 165 of which portions of the mapped memory space 171 are mapped to which of the memory sub-systems 161, . . . , 163 connected to the CXL fabric 121. The controller 122 can adjust the mapping 165 to balance the workloads on the memory sub-systems 161, . . . , 163 and thus improve the performance of the system.

The mapped memory and storage services allow the host processors (e.g., devices 118, 128, 129) connected to the CXL fabric 121 to access the mapped memory space 171 using memory addresses and memory access requests at a granularity of random memory access (e.g., in a unit of one byte, eight bytes, or 128 bytes), while the data stored into at least a portion of the memory space 171 is stored persistently in the storage spaces (e.g., 231, 233) of the memory sub-systems 161, . . . , 163. The host devices (e.g., 118, 128, 129) can be relieved from operations of entering commands in submission queues (e.g., 181, 185) configured for the memory sub-system 161, . . . , 163. At least a portion of the random access memory of the memory devices 141, 143, . . . , 145 can be used dynamically by the controller 122 as the cache memory for access in the storage spaces 231, . . . , 233 of the memory sub-systems 161, . . . , 163, without the host processors (e.g., devices 118, 128, 129) performing operations to manage or effectuate the caching.

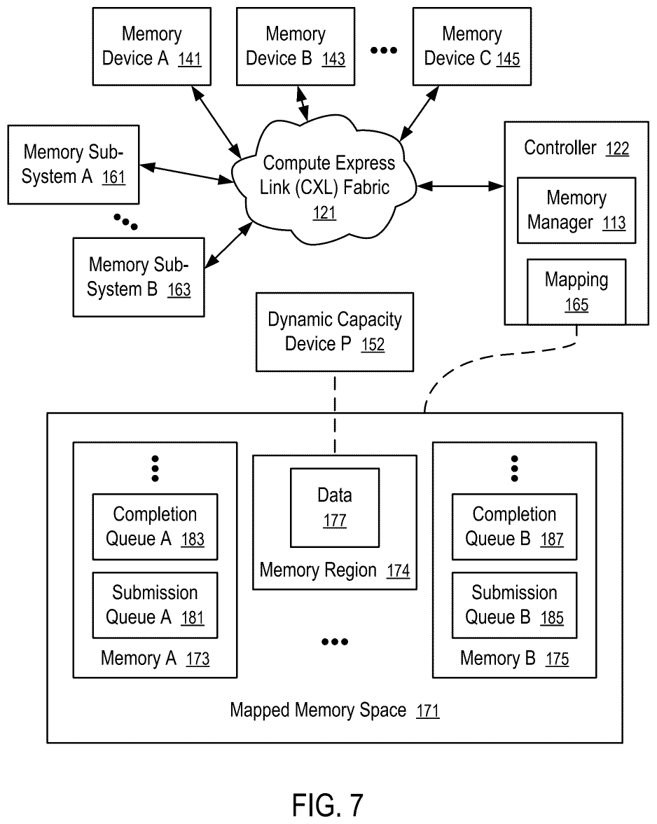

FIG. 9 shows a compute express link switch 220 configured to implement a dynamically adjustable random access memory 112 according to one embodiment. For example, the compute express link fabric switch 220 of FIG. 9 can be used to implement one or more, or each, of the switches (e.g., 221, 223 or 225) in the compute express link fabric 121 discussed above in connection with FIG. 1 to FIG. 7.

The compute express link fabric switch 220 can have a plurality of ports 235, 237, . . . , and 239. A port (e.g., 235) of the switch 220 can be connected to a memory device (e.g., 141). Such a port can be considered a device-connected port (e.g., 235). When a memory address in a memory access request is mapped to the memory device (e.g., 141) attached to the port (e.g., 235), the switch 220 routes the memory access request to the port (e.g., 235).

A port (e.g., 237) of the switch 220 can be connected to another switch (e.g., 225 or 188). Such a port (e.g., 237) can be considered a switch-connected port (e.g., 237). When a memory address in a memory access request is not mapped to the memory device (e.g., 141) attached to the port (e.g., 237), the switch 220 can route the memory access request to a switch-connected port (e.g., 237). A set of switches (e.g., 188) connected to the switch-connected port(s) (e.g., 237) of the switch 220 can be considered a fabric 126. In general, the switch 220 can have the options to route such a memory access request to more than one switch-connected port (e.g., 239) of the switch 220.

Optionally, the switch 220 can have a memory manager 113 configured to map memory access requests to its ports 235, 237, . . . , 239 according to its data of address mapping 165. Alternatively, a controller 122 configured separately from the switch 220 can provide data to instruct the switch 220 in routing the memory access requests coming into ports of the switch 220.

For example, the mapping 165 in the switch 220 and/or in the controller 122 can be configured to indicate that a portion of the memory region 174 represented by a dynamic capacity device 152 is mapped to a portion 251 in the memory device 141. For example, another portion of the memory region 174 represented by the dynamic capacity device 152 is mapped to a portion 257 in the memory sub-system 163. For example, a portion of the memory region represented by another dynamic capacity device (e.g., 154) can be mapped to a portion 253 in the memory device 141.

Since the mapping 165 can be adjusted and/or updated in the switch 220 and/or in the controller 122 without a need to restart the computing system 100 or a portion of it, the host processor 106 can request the adjustment of the capacity size of the dynamic capacity device 152, attached to implement at least a portion of its random access memory 112, without the need for restarting. When the request is received in the fabric 121, the controller 122 and/or the switch 220 can adjust the mapping 165 to implement the capacity change for the dynamic capacity device 152. Alternatively, a dynamic capacity device (e.g., 151) attached to the host processor 106 is offered by a memory device (e.g., 141); and a request to adjust its capacity size received in the fabric is routed through the fabric 121 to the memory device (e.g., 141) for execution.

At least some embodiments disclosed herein include techniques of implementing memory requested by applications running in one or more processing devices (e.g., 118) using memory regions (e.g., main memory 124 and random access memory 112) in a way to increase concurrent parallel memory access to the different memory regions for an improved system performance.

During operations of a computing system (e.g., 100 of FIG. 1), a processing device (e.g., 118) is to allocate memory for temporary storage of data (e.g., instructions, input data, output data, intermediate results). The memory requested for the operations of the processing device (e.g., 118) can be implemented using a hybrid memory system having a main memory 124 connected to the processing device 118 via a memory bus (e.g., a double data rate (DDR) bus), and a secondary random access memory 112 connected to the processing device 118 via a compute express link fabric 121. As a result, the placement of data used by the processing device (e.g., 118) is distributed across memory regions of different characteristics (e.g., main memory 124 and random access memory 112).

Interleaving data for placement across the main memory 124 and the random access memory 112 allows the increase of the total memory bandwidth used by the processing device 118. However, it is challenging to design a data placement scheme to fully utilize the total memory bandwidth provided by the main memory 124 and the random access memory 112.

Consider, for example, interleaving data for placement between the main memory 124 and the random access memory 112 at a predetermined granularity of 64 KB. When an interleaving ratio of 4:1 is used for data placement in the main memory 124 and the random access memory 112, a chunk of 64 KB of data is placed in the random access memory 112 for every 256 KB of data placed in the main memory 124.

When the data placed in the main memory 124 and the random access memory 112 is not accessed by the processing device 118 uniformly, a predetermined interleaving ratio can be different from the ratio of data actually being accessed by the processing device 118. The mismatch between the data interleaving ratio and the real time data access ratio can prevent the fully utilization of the total memory bandwidth offered by the main memory 124 and the random access memory 112.

Further, a predetermined granularity for interleaving data can be a mismatch for the granularity of data accessed by the processing device. For example, when the data accessed by an application has an access granularity (e.g., 4 KB) that is significantly different from the interleaving granularity (e.g., 64 KB), the likelihood of one of the memory region being in idle for periods of times increases. For example, during a period of time, the data to be accessed by the application can be entirely in the main memory 124; and as a result, the random access memory 112 is in an idle state, which prevents the utilization of the additional memory bandwidth provided by the random access memory 112. For example, during another period of time, the data to be accessed by the application can be entirely in the random access memory 112; and as a result, the main memory 124 is in an idle state, which can degrade the performance of the applications running in the processing device 118.

To maximize memory bandwidth utilization, the interleaving ratio and the interleaving granularity are adjusted to optimize data placement for the current workload of the computing system 100. For example, the interleaving ratio and the interleaving granularity for data placement can adapt according to the current pattern of memory workload (e.g., in view of the current access ratio and the current access granularity) to ensure that data placement as currently implemented maximizes the system memory bandwidth utilization. For example, the adaptation can be made to increase parallel access to the main memory 124 and the random access memory 112, which can lead to improvements in the overall throughput of the processing device 118.

Consider, for example, when queries are served using only the main memory 124, the processing device 118 (e.g., CPU) can process 500 queries in parallel within a total time of 10 seconds. When a smaller number of queries are served using only the random access memory 112 provided over the compute express link fabric 121, the processing device 118 (e.g., CPU) can process 50 queries in parallel in less than 10 seconds. When the 500 +50 queries are served with interleaving data placed across the main memory 124 and the random access memory 112, the total time for completing the processing in the processing device 118 can be greater than 10 seconds (e.g., when a query depends on the data from both the main memory 124 and the random access memory 112). However, when the data for the processing of each query is placed entirely in either the main memory 124 or the random access memory 112, the processing device 118 (e.g., CPU) can complete the processing of the 500 +50 queries within 10 seconds based on fully parallel usages of the main memory 124 and the random access memory 112 (assuming that the computing system 100 is not compute bound).

A reinforcement learning agent can be configured to co-optimize interleaving granularity and access ratio. Based on the current state of the computing system 100 (e.g., memory latency, memory performance, interleaving granularity, interleaving ratio, access ratio), the reinforcement learning agent is configured to perform an action of adjusting at least the interleaving granularity used to control data placement in the computing system 100. The adjustment is selected from a plurality of candidates in a way to maximize an expected reward to the reinforcement learning agent. After the implementation of the adjustment identified by the reinforcement learning agent, performance metrics can be measured to determine a reward to the reinforcement learning agent. The reinforcement learning agent is configured to update its reward model based on the reward provided according to the measured performance metrics. As the reward model converges after a period of exploration and learning, the adjustments selected by the reinforcement learning agent can configure the computing system 100 to use an improved interleaving granularity (and/or other parameters, such as an interleaving ratio) for the management of the usages of the main memory 124 and the random access memory 112. The improved memory controlling parameters (e.g., interleaving granularity and/or ratio) can lead to improved performance. The learning and/or exploration can continue to adapt the reward model to changing workloads of the computing system 100. Thus, the computing system 100 can have an improved performance in handling a variety of workloads (e.g., resettling from running different applications with different patterns of inputs and/or outputs).

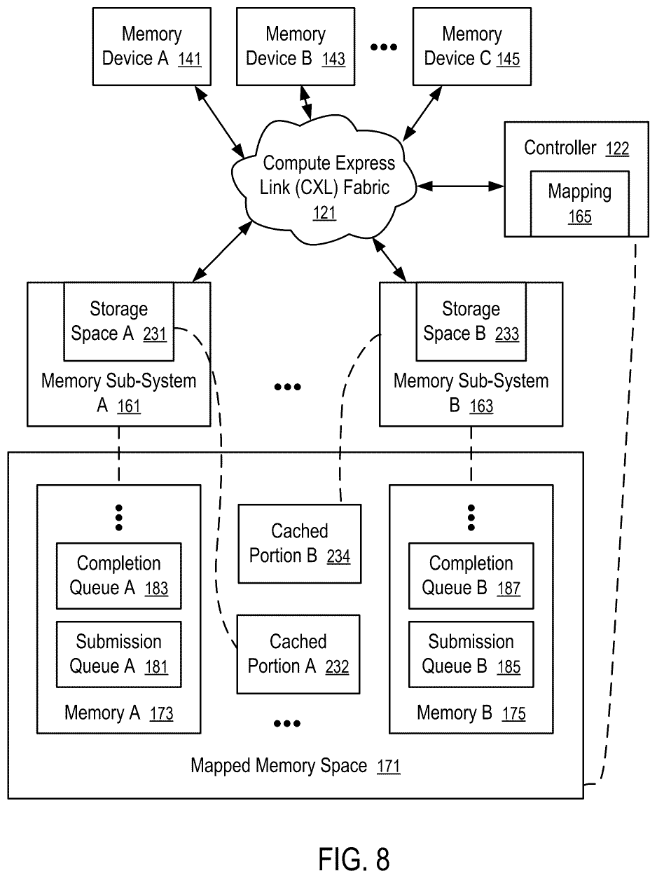

FIG. 10 shows a technique to implement requested memory using memory regions of different characteristics according to one embodiment. For example, the technique of FIG. 10 can be implemented in the computing system 100 of FIG. 1.

As an example, the computing system 100 of FIG. 1 has a heterogeneous memory system, including a main memory 124 (e.g., implemented via DRAM connected to a processing device 118 via a memory bus 109, such as a double data rate (DDR) bus), and a secondary memory (e.g., random access memory 112 implemented via memory devices 123 connected to the processing device 118 via a CXL fabric 121). The use of a CXL fabric 121 to provide the secondary memory (e.g., random access memory 112) can offer higher memory capacity and bandwidth but with increased latency.

For example, the processing device 118 in the host system 102 of FIG. 1 can request the allocation of memory 205 for use by applications running in the processing device 118. The requested memory 205 (e.g., logical memory as used in the application running in the processing device) can be implemented using physical memory allocated from different memory regions 307 and 309, such as main memory 124 and random access memory 112.

In FIG. 10, the implementation of the request memory 205 is controlled by a ratio 201 and a granularity 203.

The requested memory 205 is divided into blocks (e.g., 191, . . . , 192, 193, 194, . . . , 195, 196, . . . ) according to the granularity 203 such that the size of each block (e.g., 191 or 196) corresponds to the size of the granularity 203.

The ratio 201 controls how the blocks (e.g., 191, 196) are distributed for implementation in the memory regions 307 and 309.

For example, the ratio 201 can be a ratio between two integers, with a first integer corresponding to a share of blocks implemented using the memory region 307 and a second integer corresponding to a share of blocks implemented using the memory region 309.

The blocks (e.g., 191, . . . , 196) in the requested memory 205 are selected in an ascending (or descending) order of memory addresses according to the ratio 201 for being implemented in the memory regions 307. For example, a number of initial blocks (e.g., 191, . . . , 192) are selected for being implemented using the memory region 307, where the number is equal to the first integer. A number of subsequent blocks (e.g., 193) are selected according to the second integer for being implemented using the memory region 309. Then, a number of further subsequent blocks (e.g., 194, . . . , 195) are selected according to the first integer for being implemented in the memory region 307; and a number of further subsequent block (e.g., 196) are selected according to the second integer for being implemented in the memory region 309.

As a result, in the sequence of blocks (e.g., 191, . . . , 196) listed according to the increasing (or decreasing) order of memory address, one subset of contiguous blocks (e.g., 191, . . . , 192) and another subset of contiguous blocks (e.g., 194, . . . , 195), each having the first integer number of blocks in a respective subset and implemented in one memory region 307, are separated by a subset of blocks (e.g., 193) that are implemented in another memory region 309.

Similarly, in the sequence of blocks (e.g., 191, . . . , 196) listed according to the increasing (or decreasing) order of memory address, two subsets of contiguous blocks (e.g., 193; and 196), each having the second integer number of blocks and implemented in the memory region 309, are separated by a subset of blocks (e.g., 191, . . . , 192) that are implemented in another memory region 307. Thus, the blocks (e.g., 191, . . . , 192; 194, . . . , 195) implemented in the memory region 307 and the blocks (e.g., 193; 196) implemented in the memory region 309 are interleaved in the sequence of blocks (e.g., 191, . . . , 196, . . . .) in the requested memory 205 that are in the ascending (or descending) order of memory address.

Thus, the memory blocks (e.g., 191, . . . , 196, . . . ) of the requested memory 205 are separated and distributed for implementation in the memory regions 307 and 309 (e.g., main memory 124 and secondary random access memory 112). As a result, data in the blocks (e.g., 191, . . . , 196, . . . ) is placed in the memory regions 307 and 309 in a way corresponding to the implementations of the memory blocks (e.g., 191, . . . , 196, . . . ) in the memory regions 307 and 309. The ratio 201 also corresponds to a data placement ratio for placing data of the logical memory 205 into the memory regions 307 and 309.

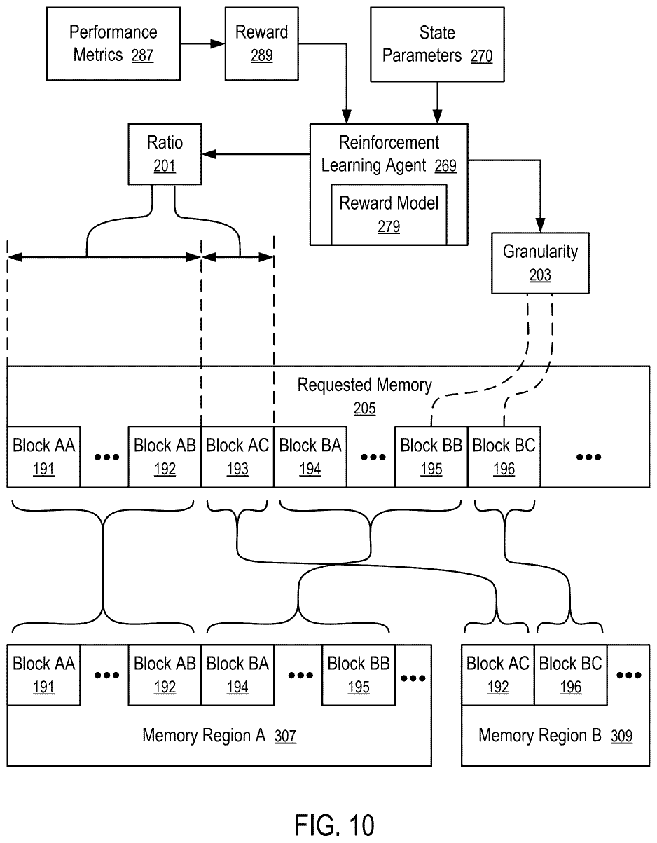

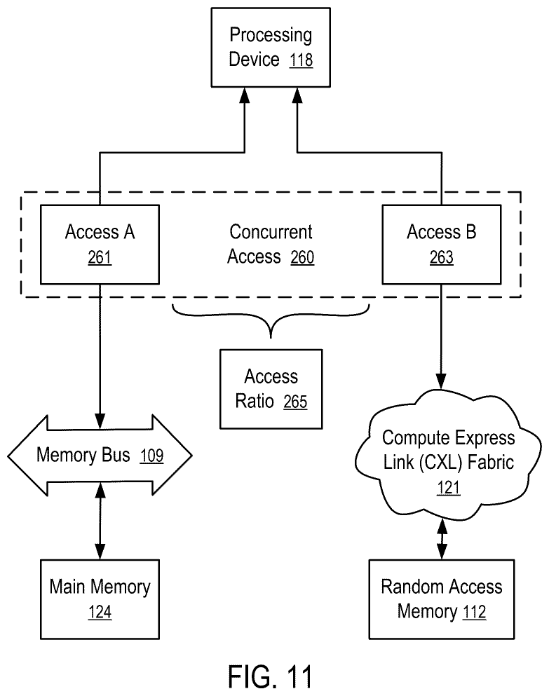

In FIG. 10, a reinforcement learning agent 269 is configured to select the ratio 201 and the granularity 203 based on a current state characterized or represented by a set of state parameters 270 (e.g., as in FIG. 12). After the ratio 201 and the granularity 203 selected by the reinforcement learning agent 269 are used to control the implementation of memory 205 requested by the processing device 118, the computing system 100 can measure the performance metrics 287 (e.g., as in FIG. 13) of the computing system 100 in processing workloads of applications running in the processing device 118.

Based on the performance metrics 287, an actual amount of reward 289 is computed and provided to the reinforcement learning agent 269. The reinforcement learning agent 269 can update its reward model in view of the selecting of the ratio 201 and the granularity 203 while the computing system 100 is at the state characterized by the state parameters 270.

After a period of exploration and learning, the reward model 279 of the reinforcement learning agent 269 can converge for the current pattern of memory workload, allowing the reinforcement learning agent 269 to select, for a current state, represented by a set of state parameters 270, the ratio 201 and the granularity 203 that, among valid candidates for selections, that are expected according to the reward model 279 to provide the largest amount of reward. In such a way, the reinforcement learning agent 269 can intelligently learn to select the ratio 201 and granularity 203 to maximize rewards, which corresponds to maximizing the performance of the computing system 100.

As the pattern of memory workload of the computing system 100 changes, the reinforcement learning agent 269 can continue its operations to learn from actual rewards (e.g., 289) provided for further selections of the ratio 201 and the granularity 203 and thus tune its reward model 279 for identifying, for the changing pattern of memory workload, the ratio 201 and granularity 203 to maximize rewards, which corresponds to maximizing the performance of the computing system 100 having changing patterns of memory workloads.

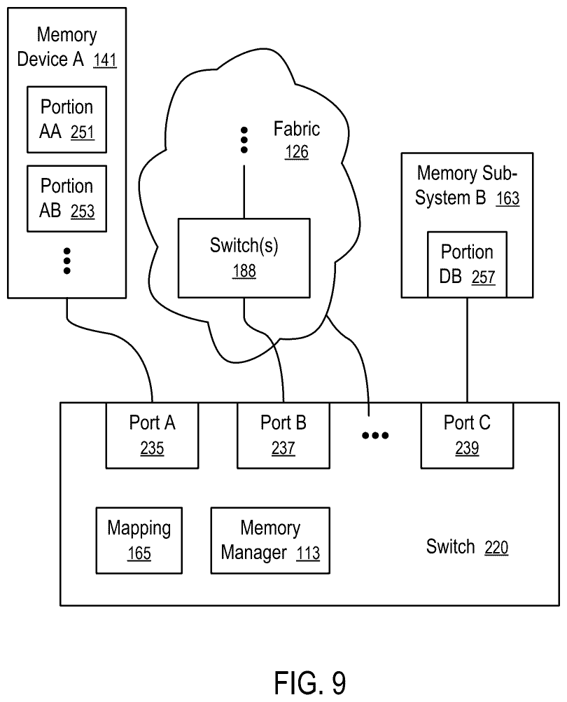

FIG. 11 shows an access ratio to be optimized using a reinforcement learning agent according to one embodiment. For example, the performance metrics 287 in FIG. 10 can include the access ratio of FIG. 11.

In FIG. 11, the processing device 118 can access different memory regions (e.g., 307 and 309 in FIG. 10) in parallel, such as main memory 124 and random access memory 112 in FIG. 1.

For example, when the processing device 118 makes an access 261 to the main memory 124 via the memory bus 109, the processing device 118 can concurrently make an access 263 to the random access memory 112 via a compute express link fabric 121. The concurrent access 260 increases the utilization of the total memory bandwidth offered by the main memory 124 and the random access memory 112 as a whole.

For example, the access ratio 265 can be a ratio between the amount of data in the access 261 made via the memory bus 109 and the amount of data in the parallel/concurrent access 263 made via the compute express link fabric 121.

In some implementations, an average of concurrent, parallel data access ratio 265 over a time period is measured and used as a performance indicator in the performance metrics 287 to identify the reward 289 to the reinforcement learning agent 269.

When the memory bandwidths of the main memory 124 and the random access memory 112 are both fully utilized in an access pattern, the access ratio 265 reaches an optimal ratio. When the access ratio deviates the optimal ratio, either the memory bandwidth of the main memory 124 is not fully utilized or the memory bandwidth of the random access memory 112 is not fully utilized.

The reward 289 to the reinforcement learning agent 269 as in FIG. 10 can be configured to cause the real time access ratio 265 of the computing system 100 to be close to, or reach the optimal ratio through reward maximizing, when the computing system 100 is running applications with the requested memory 205 implemented using different memory regions 307 and 309 (e.g., main memory 124 and secondary random access memory 112).

FIG. 11 illustrates the optimization of an access ratio 265 between the main memory 124 and the random access memory 112. The technique can be further extended to the optimization of access ratios among other memory regions that can be accessed at least partially in parallel, such as memory devices 141, 143, . . . , 145 connected to different ports of a compute express link switch (e.g., 220) and/or the compute express link fabric 121.

FIG. 12 shows an example of state parameters for a reinforcement learning agent to select parameters used in implementing requested memory according to one embodiment.

For example, the state parameters 270 in FIG. 10 can include at least some of the parameters illustrated in FIG. 12.

In FIG. 12, the state parameters 270 include memory usage statistics 271 in a recent time period of operation of the computing system 100, recent action history 272, current data placement granularity 273, current bandwidth utilization 274 of the random access memory 112 and/or the main memory 124, current data placement ratio 275, and current performance metrics 276.

The current performance metrics 276 can include the current application performance level (e.g., based on instructions per cycle (IPC) as reported by performance counters of CPU) and/or the access ratio (e.g., an average of the real time concurrent access ratio 265 as in FIG. 11 over a recent period of time).

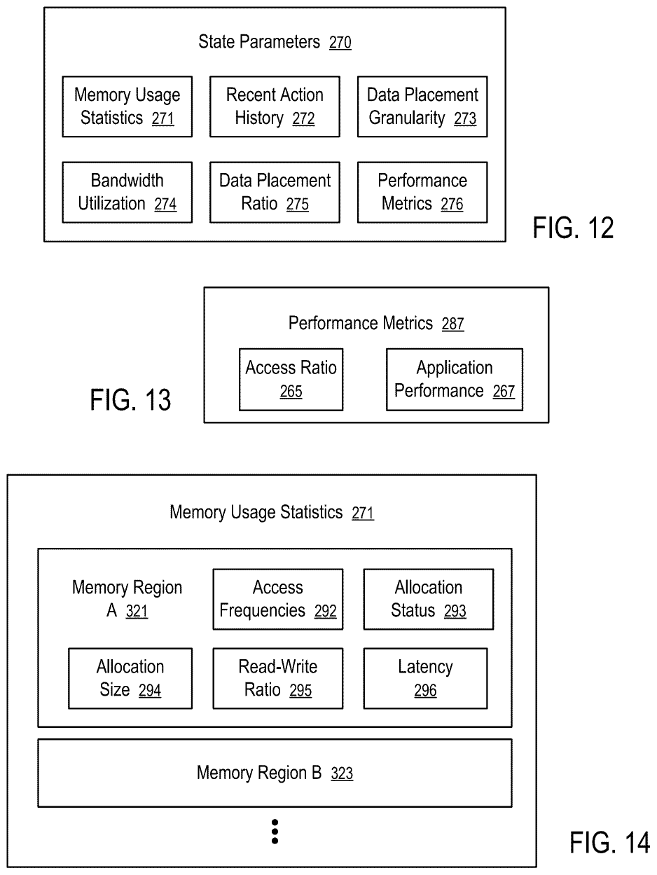

The memory usage statistics 271 can be configured to indicate the workloads of the memory devices 141, 143, . . . , and 145 and/or the main memory 124. For example, the memory usage statistics 271 can include a set of parameters for each memory region (e.g., 321, 323, as in FIG. 14).

The recent action history 272 can include up to a predetermined number of selections of memory management parameters (e.g., ratio 201 and granularity 203 in FIG. 10) that have been applied to the implementation of requested memory (e.g., 205) using memory of different characteristics (e.g., the main memory 124 and the secondary random access memory 112) to lead the computing system 100 to the current state as characterized by the state parameters 270.

The data placement granularity 273 and the data placement ratio 275 can be the current ratio 201 and granularity 203 used by the memory manager 113 to implement requested memory (e.g., 205).

FIG. 13 shows an example of performance metrics for the determination of a reward for a reinforcement learning agent to select parameters used to implement requested memory according to one embodiment.

For example, the performance metrics 287 in FIG. 10 and/or the performance metrics 276 in FIG. 12 can include at least some of the parameters illustrated in FIG. 13.

In FIG. 13, the performance metrics 287 can include an indication of access ratio 265 and an indication of application performance 267.

For example, the memory manager 113 can measure the performance metrics 287 of the computing system 100 periodically according to a predetermined time interval. The measurement results of the latest time interval can be used as the indication of the current performance metrics 287.

The access ratio 265 can be include the ratio 265 of parallel usages of the memory bandwidth of the main memory 124 and the memory bandwidth of the random access memory 112 as in FIG. 11. Optionally, the access ratio 265 can include ratio of parallel access to memory devices (e.g., 141, 143, . . . , 145) connected to different ports in the compute express link fabric 121.

For example, access ratio can be measured at a time interval that is substantially equal to the longest latency in access a portion of the memory system, including the main memory 124 and the random access memory. The average of the access ratios measured for a plurality of time intervals in a time period can be used as the access ratio 265 of the time period.

The application performance 267 can include the indicators that are based on the performance counters configured in the processing device 118 (e.g., IPC).

Optionally, the state parameters 270 and/or the performance metrics 287 can include an indication of the memory performance (e.g., in latency) of the memory devices 141, 143, . . . , 145 and/or the main memory 124. For example, the memory controller 116 can track the average latency of processing device 118 accessing the memory devices 141, 143, . . . , 145 and/or the main memory 124, during the operations of the host system 102 in a time period of a predetermined length as the memory performance indicator of the memory devices 141, 143, . . . , 145 and/or the main memory 124.

Optionally, the performance metrics 287 can include overall memory latency, overall memory throughput, overall memory pressure, and overall bandwidth utilization. For example, the overall memory latency can be the average memory latency for accessing the memory of the computing system 100, including the main memory 124 and the random access memory 112; the overall memory throughput can be the combined throughput of the memory of the computing system 100, including the main memory 124 and the random access memory 112; and the overall bandwidth utilization can be the average utilization of the memory of the computing system 100, including the main memory 124 and the random access memory 112.

FIG. 14 shows an example of memory usage statistics that can be used as part of state parameters for implementation of requested memory according to one embodiment. For example, the memory usage statistics 271 in FIG. 12 can include at least some of the parameters illustrated in FIG. 14.

For example, the random access memory 112 can be implemented using a plurality of memory devices 141, 143, . . . , 145. Each of the memory devices can include one or more memory pages mapped from logical memory pages used by applications and routines running in the processing device(s) 118 to the physical memory pages in the main memory 124 and the random access memory 112. The memory devices 141, 143, . . . , 145 and the main memory 124 can each considered a separate memory region (e.g., 321, or 323) for the tracking of its usages.

For a memory region (e.g., 321), the memory manager 113 can measure access frequencies 292, read-write ratio 295, and average latency 296, and determine allocation status 293 and allocation size 294.

For example, the memory manager 113 can measure the memory usage statistics 271 for each memory region (e.g., 321) periodically according to a predetermined time interval. The measurement results of the latest time interval can be used as the indication of the current statistics.

For example, the access frequencies 292 can be based on counts of different types of memory access (e.g., read, write, erase) to the memory region 321 during the latest time interval.

For example, the read-write ratio 295 can be based on a ratio between an amount of data read from the memory device and an amount of data written to the memory region 321 during the latest time interval.

For example, the latency 296 can be the average latency of memory access to the memory region 321 during the latest time interval.

For example, the allocation status 293 can be an indication of whether the memory region 321 contains any portion that has been allocated for use by the applications and routines running in the processing devices 118 during the latest time interval.

For example, the allocation status 293 can be an indication of whether the memory region 321 contains an average size of memory that has been allocated for use by the applications and routines running in the processing devices 118 during the latest time interval.

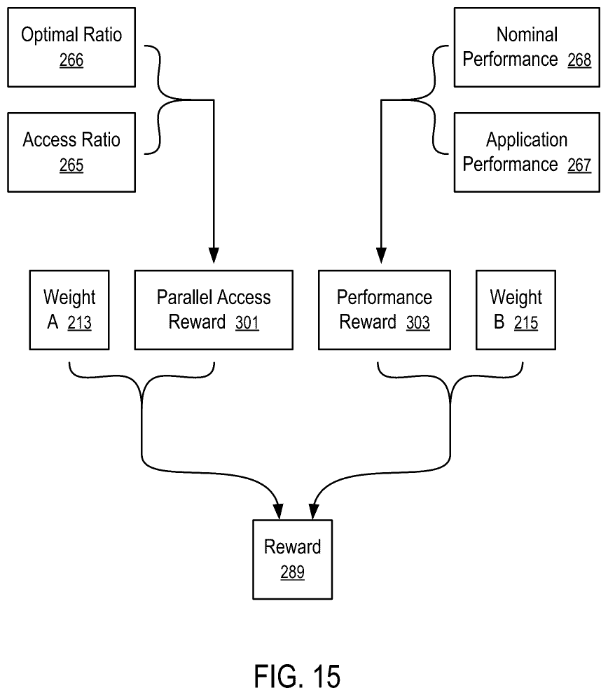

FIG. 15 shows a technique to construct a reward for a reinforcement learning agent to identify parameters to implement memory according to one embodiment.

In FIG. 15, the reward 289 to the reinforcement learning agent 269 for selecting, while the computing system 100 having the state represented by the state parameters 270, a set of parameters (e.g., ratio 201 and granularity 203 as in FIG. 10) to implement memory (e.g., 205) requested by the processing device 118 to run applications and routines is a combination of a parallel access reward 301 and a performance reward 303.

The parallel access reward 301 is configured to drive the access ratio 265 toward an optimal ratio 266 where the memory bandwidths for parallel access to memory regions (e.g., 307 and 309, such as main memory 124 and secondary random access memory 112) are fully utilized. As the access ratio 265 moves toward the optimal ratio 266, the parallel access reward 301 increases; and when the access ratio 265 moves away from the optimal ratio 266, the parallel access reward 301 decreases. For example, the abstract value of the difference between the access ratio 265 and the optimal ratio 266 can be normalized by the optimal ratio 266 to represent a penalty for the access ratio 265 being different from the optimal ratio 266. A parallel access reward 301 can be proportional to the negative version of the penalty.

The performance reward 303 is based on the application performance 267 achieved after the use of the ratio 201 and the granularity 203 is implemented in the computing system 100. The application performance 267 can be normalized using a nominal performance 268 achieved when the computing system 100 operates under a predetermined condition. For example, the performance reward 303 can be configured as a percentage of increase from the nominal performance 268 to the after-adjustment application performance 267 relative to the nominal performance 268. For example, the performance reward 303 can be computed from subtracting the nominal performance 268 from the application performance 267 and dividing the result of the subtraction by the nominal performance 268.

For example, the nominal performance 268 can be the performance of the computing system 100 configured to operate using the main memory 124 without using the secondary random access memory 112.

A weight 213 is applied to the parallel access reward 301; and another weight 215 is applied to the performance reward 303. The weighted versions of the rewards 301 and 303 can be summed to generate the reward 289.

Different ratios of the weights 213 and 215 reflect the priority placed on the goal of increasing parallel memory access and the goal of maintaining performance. Thus, the use of reward 289 as constructed in a way as illustrated in FIG. 15 can cause the reinforcement learning agent 269 to select the parameters (e.g., ratio 201 and granularity 203) for implementing requested memory (e.g., 205) that balance the goals of increasing parallel memory access and performance maintaining with priorities reflected in the ratio between the weights 213 and 215.

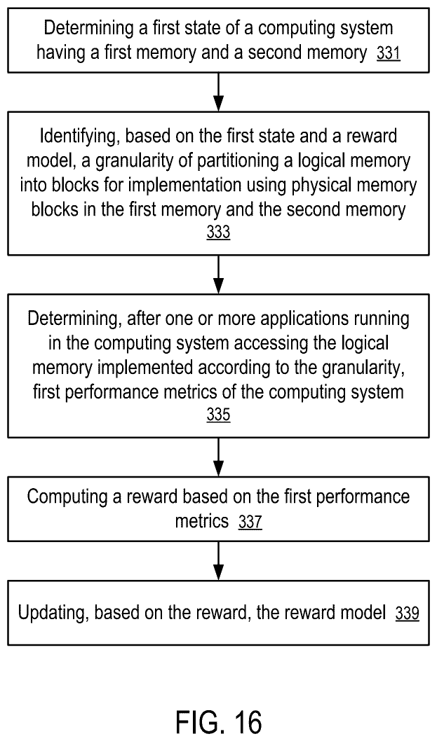

FIG. 16 shows a method to implement memory according to one embodiment.

For example, the method of FIG. 16 can be implemented in a computing system 100 of FIG. 1 having a random access memory 112 implemented using the techniques of FIG. 2 to FIG. 9. For example, a memory manager 113 can be configured in the computing system 100 to determine a ratio 201 and a granularity to implement a logical memory used by one or more applications running in the host system 102 in the computing system 100 using the reinforcement learning techniques of FIG. 10 to FIG. 15.

For example, the computing system 100 can include: a processing device 118; a main memory 124; a memory bus 109 coupled between the processing device 118 and the main memory 124; a secondary random access memory 112; and a compute express link fabric 121 separated from the memory bus 109 (e.g., a double data rate (DDR) bus) and coupled between the processing device 118 and the secondary random access memory 112. The computing system 100 is configured (e.g., via instructions and/or application specific circuits) to manage, using a reinforcement learning technique (e.g., reinforcement learning agent 269) with rewards 289 configured based at least in part on a ratio 265 of parallel/concurrent accessing 260 to the main memory 124 and the secondary random access memory 112, a granularity 203 of mapping logical memory blocks (e.g., 191, . . . , 196) to physical memory blocks (e.g., 191) in the main memory (e.g., 124; memory region 307) and in the secondary the random access memory (e.g., 112; memory region 309).

For example, the secondary random access memory 112 can be implemented using a plurality of memory devices 141, 143, . . . , 145 connected to different ports of the compute express link fabric 121. Thus, the memory devices/regions can be accessed at least in part in parallel. The ratio 201 can be configured to further include ratios of parallel accessing to the memory devices 141, 143, . . . , 145.

Optionally, the reinforcement learning agent 269 is configured in a controller 122 of the compute express link fabric 121 to identify the granularity 203 and/or the interleaving ratio 201. Alternatively, the reinforcement learning agent 269 is configured in the host system 102 (e.g., in the memory controller 116, and/or via a routing running in the processing device 118).

For example, the rewards 289 can be based on an absolute value of a difference between the access ratio 265 measured as part of performance metrics 287 of the computing system 100 and a maximal/optimal ratio 266 that can be achievable in the computing system 100 in parallel accessing the main memory 124 and the secondary random access memory 112.

For example, the reinforcement learning agent 269 can be configured to further identify an interleaving ratio 201 between first memory blocks (e.g., 191, . . . , 192; 194, . . . , 195) in the main memory 124 and second memory blocks (e.g., 193; 196) in the secondary random access memory 112. The memory manager 113 can interleave the first memory blocks (e.g., 191, . . . , 192; 194, . . . , 195) and the second memory blocks (e.g., 193; 196) according to the interleaving ratio 201 to implement the logical memory blocks (e.g., as in FIG. 10).

At block 331, the method of FIG. 16 includes determining a first state (e.g., represented by a set of state parameters 270 as illustrated in FIG. 12) of a computing system 100 having a first memory (e.g., main memory 124) and a second memory (e.g., secondary random access memory 112).

At block 333, the method includes identifying, based on the first state (e.g., represented by the state parameters 270) and a reward model 279, a granularity 203 of partitioning a logical memory (e.g., 205) into blocks (e.g., 191, . . . , 196) for implementation using physical memory blocks (e.g., 191, . . . , 196) in the first memory (e.g., main memory 124) and the second memory (e.g., secondary random access memory 112).

Optionally, the method of FIG. 16 can further include: identifying, based on the first state (e.g., represented by the state parameters 270) and the reward model 279, a ratio 201 of a first number of first memory blocks (e.g., 191, . . . , 192) in the first memory (e.g., memory region 307, such as main memory 124) and a second number of second memory blocks (e.g., 193) in the second memory (e.g., memory region 309, such as secondary random access memory 112). The logical memory (e.g., 205 as requested by applications running in the processing device 118) is implemented according to the interleaving ratio 201 using the first memory blocks (e.g., 191, . . . , 192) and the second memory blocks (e.g., 193) having the granularity 203.

For example, the first memory blocks (e.g., 191, . . . , 192; 194, . . . , 195) and the second memory blocks (e.g., 192, 196) are interleaved to implement the logical memory 205 according to an ascending or descending order of memory addresses in the logical memory 205.

At block 335, the method includes determining, after one or more applications running in the computing system 100 accessing the logical memory 205 implemented according to the granularity 203, first performance metrics 287 (e.g., as in FIG. 13) of the computing system 100.

For example, the first performance metrics 287 can include an access ratio 265 of parallel/concurrent accesses (e.g., 261, 263) to the first memory (e.g., main memory 124) and the second memory (e.g., random access memory 112).

For example, the method of FIG. 16 can further include: determining the access ratio 265 for a period of time from an average of a plurality of first access ratios (e.g., 265), each measured for a time interval of a predetermined length within the period of time. For example, the time interval of the predetermined length can be substantially equal to (e.g., less than twice of) a latency of access by the processing device 118 to a portion of the first memory (e.g., 307) or the second memory (e.g., 309).

At block 337, the method includes computing a reward 289 based on the first performance metrics 287.

For example, the reward 289 can be based on a difference between the access ratio 265 and an optimal ratio 266 of accessing the first memory (e.g., 307) and the second memory (e.g., 309) in parallel with full utilization of memory bandwidth of the first memory (e.g., 307, such as main memory 124) and memory bandwidth of the second memory (e.g., 309, such as random access memory 112).

For example, the reward 289 can be based on a negative version of an absolute value of the different normalized by the optimal ratio 266.

At block 339, the method includes updating, based on the reward 289, the reward model 289 (e.g., using a reinforcement learning technique implemented in a reinforcement learning agent 269).

The operations of FIG. 16 can repeat in iterations. After a number of iterations of exploration and learning, the reward model 289 can converge. For a given set of state parameters, the reinforcement learning agent 269 can select, from interleaving ratio candidates and granularity candidates, an interleaving ratio 201 and a granularity 203 that can provide the largest reward as predicted by the reward model 289. The actual reward 289 deviates from the reward predicted by the reward model 289, the reinforcement learning agent 269 can adjust the reward model 289 to improve predictions. Thus, the reward model 279 can adapt to the changes in the workloads in the computing system 100 to maximize rewards to the reinforcement learning agent 269 and thus drive the access ratio 265 towards the optimal ratio 265 and to improve application performance 267.

A non-transitory computer storage medium can be used to store instructions programmed to implement a memory manager 113 configured to perform operations discussed above in connection with the main memory 124 and the random access memory 112 in a secondary tier memory of a host processor 106, including the operations of the reinforcement learning agent 269. When the instructions are executed by the processing device 118, the controller 115, the processing device 117, the controller 122, and/or the compute express link switches (e.g., 220; 221, 223, . . . , 225), the instructions cause the computing system 100 to perform the methods discussed above.

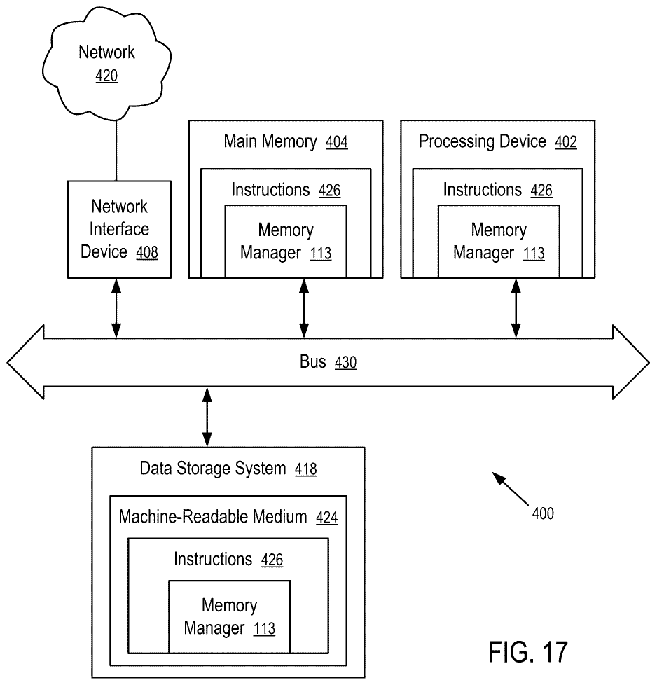

FIG. 17 illustrates an example machine of a computer system 400 within which a set of instructions, for causing the machine to perform any one or more of the methodologies discussed herein, can be executed. In some embodiments, the computer system 400 can correspond to a host system (e.g., the host system 102 of FIG. 1) that includes, is coupled to, or utilizes a memory sub-system (e.g., the memory sub-system 101 of FIG. 1) or can be used to perform the operations of memory managers 113 (e.g., to execute instructions to perform operations corresponding to the memory managers 113 described with reference to FIG. 1-16). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a personal digital assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 400 includes a processing device 402, a main memory 404 (e.g., read-only memory (ROM), flash memory, dynamic random access memory (DRAM) such as synchronous DRAM (SDRAM) or Rambus DRAM (RDRAM), static random access memory (SRAM), etc.), and a data storage system 418, which communicate with each other via a bus 430 (which can include multiple buses).

Processing device 402 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 402 can also be one or more special-purpose processing devices such as an application specific integrated circuit (ASIC), a field programmable gate array (FPGA), a digital signal processor (DSP), network processor, or the like. The processing device 402 is configured to execute instructions 426 for performing the operations and steps discussed herein. The computer system 400 can further include a network interface device 408 to communicate over the network 420.

The data storage system 418 can include a machine-readable medium 424 (also known as a computer-readable medium) on which is stored one or more sets of instructions 426 or software embodying any one or more of the methodologies or functions described herein. The instructions 426 can also reside, completely or at least partially, within the main memory 404 and/or within the processing device 402 during execution thereof by the computer system 400, the main memory 404 and the processing device 402 also constituting machine-readable storage media. The machine-readable medium 424, data storage system 418, and/or main memory 404 can correspond to the memory sub-system 101 of FIG. 1.

In one embodiment, the instructions 426 include instructions to implement functionality corresponding to the memory managers 113 described with reference to FIG. 1-16. While the machine-readable medium 424 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to convey the substance of their work most effectively to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In this description, various functions and operations are described as being performed by or caused by computer instructions to simplify description. However, those skilled in the art will recognize what is meant by such expressions is that the functions result from execution of the computer instructions by one or more controllers or processors, such as a microprocessor. Alternatively, or in combination, the functions and operations can be implemented using special purpose circuitry, with or without software instructions, such as using application-specific integrated circuit (ASIC) or field-programmable gate array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

1. A method, comprising:
determining a first state of a computing system having a first memory and a second memory;
identifying, based on the first state and a reward model, a granularity of partitioning a logical memory into blocks for implementation using physical memory blocks in the first memory and the second memory; and
determining, after one or more applications running in the computing system accessing the logical memory implemented according to the granularity, first performance metrics of the computing system.

2. The method of claim 1, further comprising:
computing a reward based on the first performance metrics; and
updating, based on the reward, the reward model;
identifying, based on the first state and the reward model, a ratio of a first number of first memory blocks in the first memory and a second number of second memory blocks in the second memory;
wherein the logical memory is implemented according to the ratio using the first memory blocks and the second memory blocks having the granularity.

3. The method of claim 2, wherein the first memory is connected to a processing device in the computing system via a memory bus; and the second memory is connected to the processing device via a compute express link fabric.

4. The method of claim 3, wherein the first performance metrics include an access ratio of parallel accesses to the first memory and the second memory.

5. The method of claim 4, further comprising:
determining the access ratio for a period of time from an average of a plurality of first access ratios, each measured for a time interval of a predetermined length within the period of time.

6. The method of claim 5, wherein the time interval of the predetermined length is substantially equal to a latency of access to a portion of the first memory or the second memory.

7. The method of claim 4, wherein the first memory blocks and the second memory blocks are interleaved to implement the logical memory according to an ascending or descending order of memory addresses in the logical memory.

8. The method of claim 7, wherein the reward is based on a difference between the access ratio and an optimal ratio of accessing the first memory and the second memory in parallel with full utilization of memory bandwidth of the first memory and memory bandwidth of the second memory.

9. The method of claim 8, wherein the reward is further based on an absolute value of the difference normalized by the optimal ratio.

10. The method of claim 9, wherein the memory bus is a double data rate (DDR) bus.

11. A system, comprising:
a processing device;
a main memory;
a memory bus coupled between the processing device and the main memory;
a secondary random access memory; and
a compute express link fabric separated from the memory bus and coupled between the processing device and the secondary random access memory.

12. The system of claim 11, wherein the system is configured to manage, using a reinforcement learning technique with rewards configured based at least in part on a ratio of parallel accessing to the main memory and the secondary random access memory, a granularity of mapping logical memory blocks to physical memory blocks in the main memory and in the secondary random access memory;
wherein the secondary random access memory is implemented using a plurality of memory devices; and the ratio further includes ratios of parallel accessing to the memory devices.

13. The system of claim 12, wherein the memory bus is a double data rate (DDR) bus.

14. The system of claim 12, wherein a reinforcement learning agent is configured in a controller of the compute express link fabric to identify the granularity.

15. The system of claim 14, wherein the ratio is a first ratio; and the rewards are based on an absolute value of a difference between the first ratio and a maximal ratio achievable in the system in parallel accessing the main memory and the secondary random access memory.

16. The system of claim 15, wherein the reinforcement learning agent is further configured to identify a second ratio between first memory blocks in the main memory and second memory blocks in the secondary random access memory, the first memory blocks and the second memory blocks interleaved according to the second ratio to implement the logical memory blocks.

17. A non-transitory computer storage medium storing instructions which, when executed by a computing system, cause the computing system to perform a method, comprising:
determining, using a reinforcement learning technique with rewards configured based at least in part on a ratio of parallel accessing to a main memory and a secondary random access memory, a granularity.

18. The non-transitory computer storage medium of claim 17, the method further comprising:
mapping, according to the granularity, logical memory blocks to physical memory blocks in the main memory and in the secondary random access memory;
wherein the main memory is coupled to a processing device in the computing system via a memory bus; and the secondary random access memory is coupled to the processing device via a compute express link fabric separate from the memory bus.

19. The non-transitory computer storage medium of claim 18, wherein the ratio is a first ratio; and the method further comprises:
identifying, using the reinforcement learning technique, a second ratio;
wherein first memory blocks in the main memory and second memory blocks in the secondary random access memory are interleaved according to the second ratio to implement the logical memory blocks.

20. The non-transitory computer storage medium of claim 19, wherein the rewards are based on an absolute value of a difference between the first ratio and a maximal ratio achievable in the computing system in parallel accessing the main memory and the secondary random access memory.
